(19) United States
(12) Patent Application Publication
(10) Pub. No.: US 2024/0144949 A1
(43) Pub. Date: May 2, 2024

(54) Systems and Methods for Providing User Experiences on AR/VR Systems

(71) Applicant: Meta Platforms Technologies, LLC, Menlo Park, CA (US)

(72) Inventors: Xiao Yang, Savoy, IL (US); Ahmed Kamal Atwa Mohamed, Redmond, WA (US); Charles Ye, Columbus, GA (US); Nikita Bhalla, San Francisco, CA (US); Shashank Jain, Sunnyvale, CA (US); Mahek Parvez Hooda, Kirkland, WA (US); Gagan Aneja, Newark, CA (US); Stanislav Peshterliev, Redmond, WA (US); Pranab Mohanty, Redmond, WA (US); Gerald Eugene McAlister, Seattle, WA (US); Gautam Venkatesan, Oakland, CA (US); Ju Lin, Seattle, WA (US); Ruiming Xie, London (GB); Niko Moritz, Kingston Upon Thames (GB); Frank Torsten Bernd Seide, Yarrow Point, WA (US)

(21) Appl. No.: 18/493,555

(22) Filed: Oct. 24, 2023

Related U.S. Application Data
(60) Provisional application No. 63/381,211, filed on Oct. 27, 2022.
(60) Provisional application No. 63/507,645, filed on Jun. 12, 2023.
(60) Provisional application No. 63/516,289, filed on Jul. 28, 2023.

(51) Int. Cl. G10L 21/0216; G06F 40/58; G10L 17/02; G10L 17/04; G10L 17/14; H04R 3/00; H04R 5/027; H04S 3/00; H04S 7/00

(52) U.S. Cl. CPC G10L 21/0216; G06F 40/58; G10L 17/02; G10L 17/04; G10L 17/14; H04R 3/005; H04R 5/027; H04S 3/008; H04S 7/302; G10L 2021/02087; H04R 2499/15; H04S 2400/01; H04S 2400/11; H04S 2400/15

(57) ABSTRACT

In one embodiment, an AR/VR system includes a social-networking application installed on the AR/VR system, which allows a user to access on online social network, including communicating with the user's social connections and interacting with content objects on the online social network. The AR/VR system also includes an AR/VR application, which allows the user to interact with an AR/VR platform by providing user input to the AR/VR application via various modalities. Based on the user input, the AR/VR platform generates responses and sends the generated responses to the AR/VR application, which then presents the responses to the user at the AR/VR system via various modalities.

### PRIORITY

This application claims the benefit under 35 U.S.C. § 119(e) of U.S. Provisional Patent Application No. 63/381,211, filed 27 Oct. 2022, U.S. Provisional Patent Application No. 63/507,645, filed 12 Jun. 2023, and U.S. Provisional Patent Application No. 63/516,289, filed 28 Jul. 2023, each of which is incorporated herein by reference.

### TECHNICAL FIELD

This disclosure generally relates to databases and file management within network environments, and in particular relates to application management for augmented-reality (AR) and virtual-reality (VR) systems.

### BACKGROUND

Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. In this way, augmented reality alters one's ongoing perception of a real-world environment. Augmented reality is related to two largely synonymous terms: mixed reality and computer-mediated reality.

Virtual reality (VR) is a simulated experience that can be similar to or completely different from the real world. Applications of virtual reality include entertainment (particularly video games), education (such as medical or military training) and business (such as virtual meetings). Standard virtual reality systems use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

### BRIEF DESCRIPTION OF THE DRAWINGS

FIG. 1 illustrates an example network environment associated with an augmented-reality (AR)/virtual-reality (VR) system.

FIG. 2 illustrates an example augmented-reality (AR) system.

FIG. 3 illustrates an example virtual-reality (VR) system worn by a user.

FIG. 4 illustrates example microphone locations on smart glasses.

FIG. 5 illustrates an example architecture of directional speech recognition.

FIG. 6 illustrates an example data simulation diagram.

FIG. 7 illustrates an example process for multi-talker simulation.

FIG. 8 illustrates examples of adding distractor to the simulation.

FIG. 9 illustrates an example pipeline for multi-channel data simulation.

FIG. 10 illustrates an example simulation of 7-channel data associated with AR glasses.

FIG. 11 illustrates example training configuration of spatial positions of the conversation partner and bystander.

FIG. 12 illustrates example beam patterns of the super-directive beamformer at frequency of 2 kHz.

FIG. 13 illustrates an example chart showing our best results.

FIG. 14 illustrates an example method for suppressing crosstalk.

FIG. 15 illustrates an example framework for label error detection and overwrite.

FIG. 16 illustrates another example flow diagram to achieve better data efficiency.

FIG. 17 illustrates another example flow diagram to achieve better data efficiency.

FIG. 18 illustrates an example flow diagram for assisting human annotators.

FIG. 19 illustrates an example QA system architecture.

FIG. 20 illustrates example changes in the new MRC model.

FIG. 21 illustrates an example sequence diagram of a process for switching the audio communication for the user the first audio channel to a second audio channel when changing context in an XR environment.

FIG. 22 illustrates an example computer system.

### DESCRIPTION OF EXAMPLE EMBODIMENTS

### System Overview

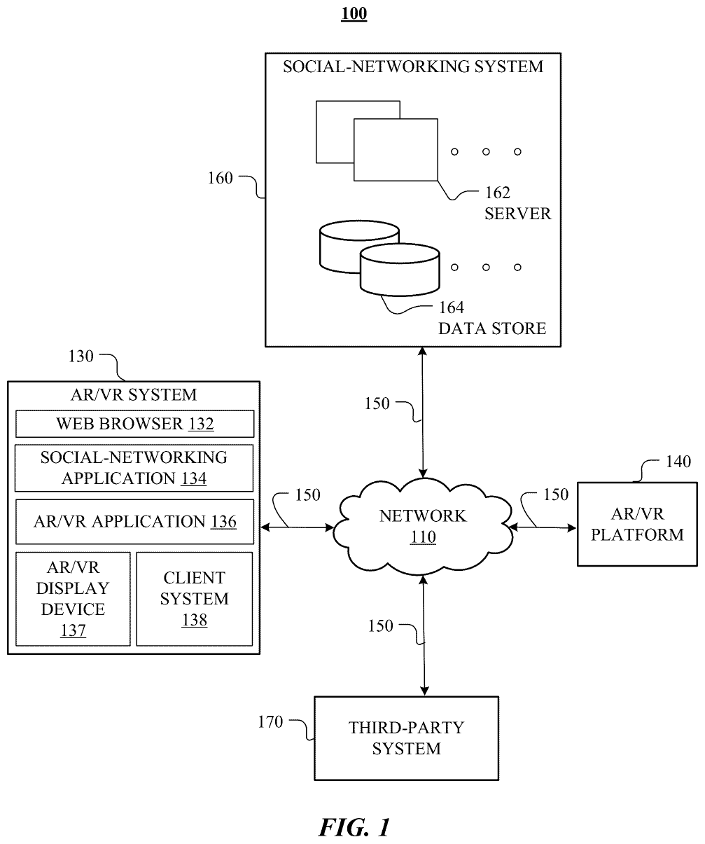

FIG. 1 illustrates an example network environment 100 associated with an augmented-reality (AR)/virtual-reality (VR) system 130. Network environment 100 includes the AR/VR system 130, an AR/VR platform 140, a social-networking system 160, and a third-party system 170 connected to each other by a network 110. Although FIG. 1 illustrates a particular arrangement of an AR/VR system 130, an AR/VR platform 140, a social-networking system 160, a third-party system 170, and a network 110, this disclosure contemplates any suitable arrangement of an AR/VR system 130, an AR/VR platform 140, a social-networking system 160, a third-party system 170, and a network 110. As an example and not by way of limitation, two or more of an AR/VR system 130, a social-networking system 160, an AR/VR platform 140, and a third-party system 170 may be connected to each other directly, bypassing a network 110. As another example, two or more of an AR/VR system 130, an AR/VR platform 140, a social-networking system 160, and a third-party system 170 may be physically or logically co-located with each other in whole or in part. Moreover, although FIG. 1 illustrates a particular number of AR/VR systems 130, AR/VR platforms 140, social-networking systems 160, third-party systems 170, and networks 110, this disclosure contemplates any suitable number of AR/VR systems 130, AR/VR platforms 140, social-networking systems 160, third-party systems 170, and networks 110. As an example and not by way of limitation, network environment 100 may include multiple AR/VR systems 130, AR/VR platforms 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect an AR/VR system 130, an AR/VR platform 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, an AR/VR system 130 may be any suitable electronic device including hardware, software, or embedded logic components, or a combination of two or more such components, and may be capable of carrying out the functionalities implemented or supported by an AR/VR system 130. As an example and not by way of limitation, the AR/VR system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual-reality (VR) headset, other suitable electronic device, or any suitable combination thereof. This disclosure contemplates any suitable AR/VR systems 130. In particular embodiments, an AR/VR system 130 may enable a network user at an AR/VR system 130 to access a network 110. The AR/VR system 130 may also enable the user to communicate with other users at other AR/VR systems 130.

In particular embodiments, an AR/VR system 130 may include a web browser 132, and may have one or more add-ons, plug-ins, or other extensions. A user at an AR/VR system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to an AR/VR system 130 one or more Hyper Text Markup Language (HTML) files responsive to the HTTP request. The AR/VR system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, an AR/VR system 130 may include a social-networking application 134 installed on the AR/VR system 130. A user at an AR/VR system 130 may use the social-networking application 134 to access on online social network. The user at the AR/VR system 130 may use the social-networking application 134 to communicate with the user's social connections (e.g., friends, followers, followed accounts, contacts, etc.). The user at the AR/VR system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, an AR/VR system 130 may include an AR/VR application 136. As an example and not by way of limitation, an AR/VR application 136 may be able to incorporate AR/VR renderings of real-world objects from the real-world environment into an AR/VR environment. A user at an AR/VR system 130 may use the AR/VR applications 136 to interact with the AR/VR platform 140. In particular embodiments, the AR/VR application 136 may comprise a stand-alone application. In particular embodiments, the AR/VR application 136 may be integrated into the social-networking application 134 or another suitable application (e.g., a messaging application). In particular embodiments, the AR/VR application 136 may be also integrated into the AR/VR system 130, an AR/VR hardware device, or any other suitable hardware devices. In particular embodiments, the AR/VR application 136 may be also part of the AR/VR platform 140. In particular embodiments, the AR/VR application 136 may be accessed via the web browser 132. In particular embodiments, the user may interact with the AR/VR platform 140 by providing user input to the AR/VR application 136 via various modalities (e.g., audio, voice, text, vision, image, video, gesture, motion, activity, location, orientation). The AR/VR application 136 may communicate the user input to the AR/VR platform 140. Based on the user input, the AR/VR platform 140 may generate responses. The AR/VR platform 140 may send the generated responses to the AR/VR application 136. The AR/VR application 136 may then present the responses to the user at the AR/VR system 130 via various modalities (e.g., audio, text, image, video, and VR/AR rendering). As an example and not by way of limitation, the user may interact with the AR/VR platform 140 by providing a user input (e.g., a verbal request for information of an object in the AR/VR environment) via a microphone of the AR/VR system 130. The AR/VR application 136 may then communicate the user input to the AR/VR platform 140 over network 110. The AR/VR platform 140 may accordingly analyze the user input, generate a response based on the analysis of the user input, and communicate the generated response back to the AR/VR application 136. The AR/VR application 136 may then present the generated response to the user in any suitable manner (e.g., displaying a text-based push notification and/or AR/VR rendering(s) illustrating the information of the object on a display of the AR/VR system 130).

In particular embodiments, an AR/VR system 130 may include an AR/VR display device 137 and, optionally, a client system 138. The AR/VR display device 137 may be configured to render outputs generated by the AR/VR platform 140 to the user. The client system 138 may comprise a companion device. The client system 138 may be configured to perform computations associated with particular tasks (e.g., communications with the AR/VR platform 140) locally (i.e., on-device) on the client system 138 in particular circumstances (e.g., when the AR/VR display device 137 is unable to perform said computations). In particular embodiments, the AR/VR system 130, the AR/VR display device 137, and/or the client system 138 may each be a suitable electronic device including hardware, software, or embedded logic components, or a combination of two or more such components, and may be capable of carrying out, individually or cooperatively, the functionalities implemented or supported by the AR/VR system 130 described herein. As an example and not by way of limitation, the AR/VR system 130, the AR/VR display device 137, and/or the client system 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual-reality (VR) headset, augmented-reality (AR) smart glasses, other suitable electronic device, or any suitable combination thereof. In particular embodiments, the AR/VR display device 137 may comprise a VR headset and the client system 138 may comprise a smart phone. In particular embodiments, the AR/VR display device 137 may comprise AR smart glasses and the client system 138 may comprise a smart phone.

In particular embodiments, a user may interact with the AR/VR platform 140 using the AR/VR display device 137 or the client system 138, individually or in combination. In particular embodiments, an application on the AR/VR display device 137 may be configured to receive user input from the user, and a companion application on the client system 138 may be configured to handle user inputs (e.g., user requests) received by the application on the AR/VR display device 137. In particular embodiments, the AR/VR display device 137 and the client system 138 may be associated with each other (i.e., paired) via one or more wireless communication protocols (e.g., Bluetooth).

The following example workflow illustrates how an AR/VR display device 137 and a client system 138 may handle a user input provided by a user. In this example, an application on the AR/VR display device 137 may receive a user input comprising a user request directed to the VR display device 137. The application on the AR/VR display device 137 may then determine a status of a wireless connection (i.e., tethering status) between the AR/VR display device 137 and the client system 138. If a wireless connection between the AR/VR display device 137 and the client system 138 is not available, the application on the AR/VR display device 137 may communicate the user request (optionally including additional data and/or contextual information available to the AR/VR display device 137) to the AR/VR platform 140 via the network 110. The AR/VR platform 140 may then generate a response to the user request and communicate the generated response back to the AR/VR display device 137. The AR/VR display device 137 may then present the response to the user in any suitable manner. Alternatively, if a wireless connection between the AR/VR display device 137 and the client system 138 is available, the application on the AR/VR display device 137 may communicate the user request (optionally including additional data and/or contextual information available to the AR/VR display device 137) to the companion application on the client system 138 via the wireless connection. The companion application on the client system 138 may then communicate the user request (optionally including additional data and/or contextual information available to the client system 138) to the AR/VR platform 140 via the network 110. The AR/VR platform 140 may then generate a response to the user request and communicate the generated response back to the client system 138. The companion application on the client system 138 may then communicate the generated response to the application on the AR/VR display device 137. The AR/VR display device 137 may then present the response to the user in any suitable manner. In the preceding example workflow, the AR/VR display device 137 and the client system 138 may each perform one or more computations and/or processes at each respective step of the workflow. In particular embodiments, performance of the computations and/or processes disclosed herein may be adaptively switched between the AR/VR display device 137 and the client system 138 based at least in part on a device state of the AR/VR display device 137 and/or the client system 138, a task associated with the user input, and/or one or more additional factors. As an example and not by way of limitation, one factor may be signal strength of the wireless connection between the AR/VR display device 137 and the client system 138. For example, if the signal strength of the wireless connection between the AR/VR display device 137 and the client system 138 is strong, the computations and processes may be adaptively switched to be substantially performed by the client system 138 in order to, for example, benefit from the greater processing power of the CPU of the client system 138. Alternatively, if the signal strength of the wireless connection between the AR/VR display device 137 and the client system 138 is weak, the computations and processes may be adaptively switched to be substantially performed by the AR/VR display device 137 in a standalone manner. In particular embodiments, if the AR/VR system 130 does not comprise a client system 138, the aforementioned computations and processes may be performed solely by the AR/VR display device 137 in a standalone manner.

In particular embodiments, the AR/VR platform 140 may comprise a backend platform or server for the AR/VR system 130. The AR/VR platform 140 may interact with the AR/VR system 130, and/or the social-networking system 160, and/or the third-party system 170 when executing tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, an AR/VR system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable an AR/VR system 130, a social-networking system 160, an AR/VR platform 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. As an example and not by way of limitation, the entity operating the third-party system 170 may be a developer for one or more AR/VR applications 136. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. As an example and not by way of limitation, the third-party content object provider may be a developer for one or more AR/VR applications 136. A third-party content object provider may include one or more sources of content objects, which may be communicated to an AR/VR system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. As yet another example and not by way of limitation, content objects may include one or more AR/VR applications 136. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from an AR/VR system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more AR/VR systems 130 or one or more third-party systems 170 via a network 110. The web server may include a mail server or other messaging functionality for receiving and routing messages between the social-networking system 160 and one or more AR/VR systems 130. An API-request server may allow, for example, an AR/VR platform 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to an AR/VR system 130. Information may be pushed to an AR/VR system 130 as notifications, or information may be pulled from an AR/VR system 130 responsive to a user input comprising a user request received from an AR/VR system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from AR/VR systems 130 associated with users. Advertisement-pricing modules may combine social information, the current time, location information, or other suitable information to provide relevant advertisements, in the form of notifications, to a user.

### Augmented-Reality Systems

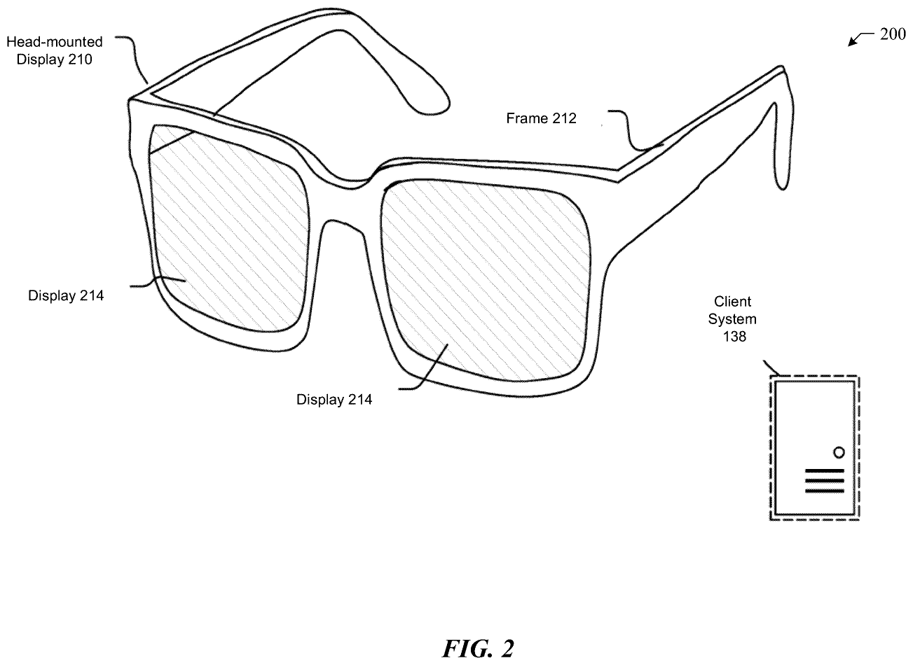

FIG. 2 illustrates an example augmented-reality system 200. In particular embodiments, the augmented-reality system 200 can perform one or more processes as described herein. The augmented-reality system 200 may include a head-mounted display (HMD) 210 (e.g., glasses) comprising a frame 212, one or more displays 214, and a client system 138. The displays 214 may be transparent or translucent allowing a user wearing the HMD 210 to look through the displays 214 to see the real world and displaying visual artificial reality content to the user at the same time. The HMD 210 may include an audio device that may provide audio artificial reality content to users. The HMD 210 may include one or more cameras which can capture images and videos of environments. The HMD 210 may include an eye tracking system to track the vergence movement of the user wearing the HMD 210. The HMD 210 may include a microphone to capture voice input from the user. The augmented-reality system 200 may further include a controller comprising a trackpad and one or more buttons. The controller may receive inputs from users and relay the inputs to the client system 138. The controller may also provide haptic feedback to users. The client system 138 may be connected to the HMD 210 and the controller through cables or wireless connections. The client system 138 may control the HMD 210 and the controller to provide the augmented-reality content to and receive inputs from users. The client system 138 may be a standalone host computer device, an on-board computer device integrated with the HMD 210, a mobile device, or any other hardware platform capable of providing augmented-reality content to and receiving inputs from users.

Object tracking within the image domain is a known technique. For example, a stationary camera may capture a video of a moving object, and a computing system may compute, for each frame, the 3D position of an object of interest or one of its observable features relative to the camera. When the camera is stationary, any change in the object's position is attributable only to the object's movement and/or jitter caused by the tracking algorithm. In this case, the motion of the tracked object could be temporally smoothed by simply applying a suitable averaging algorithm (e.g., averaging with an exponential temporal decay) to the current estimated position of the object and the previously estimated position(s) of the object.

Motion smoothing becomes much more complex in the context of augmented reality. For augmented-reality systems, an external-facing camera is often mounted on the HMD and, therefore, could be capturing a video of another moving object while moving with the user's head. When using such a non-stationary camera to track a moving object, the tracked positional changes of the object could be due to not only the object's movements but also the camera's movements. Therefore, the aforementioned method for temporally smoothing the tracked positions of the object would no longer work.

### Virtual-Reality Systems

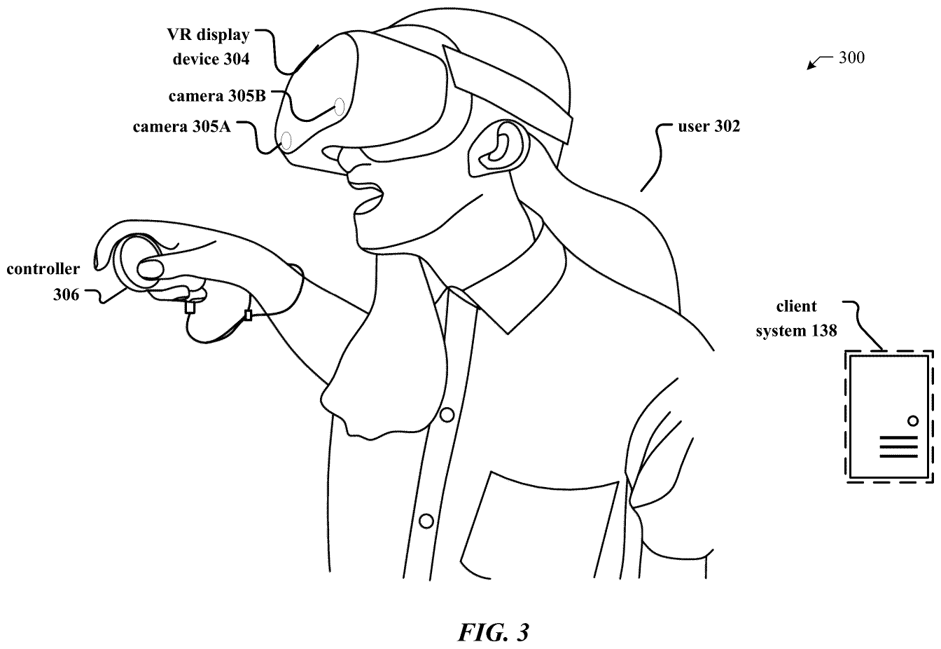

FIG. 3 illustrates an example of a virtual reality (VR) system 300 worn by a user 302. In particular embodiments, the VR system 300 may comprise a head-mounted VR display device 304, a controller 306, and one or more client systems 138. The VR display device 304 may be worn over the user's eyes and provide visual content to the user 302 through internal displays (not shown). The VR display device 304 may have two separate internal displays, one for each eye of the user 302 (single display devices are also possible). In particular embodiments, the VR display device 304 may comprise one or more external-facing cameras, such as the two forward-facing cameras 305A and 305B, which can capture images and videos of the real-world environment. The VR system 300 may further include one or more client systems 138. The one or more client systems 138 may be a stand-alone unit that is physically separate from the VR display device 304 or the client systems 138 may be integrated with the VR display device 304. In embodiments where the one or more client systems 138 are a separate unit, the one or more client systems 138 may be communicatively coupled to the VR display device 304 via a wireless or wired link. The one or more client systems 138 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by a VR system 300 depends on the capabilities of its one or more client systems 138.

### Suppressing Crosstalk for User Conversations Based on Directional Information

In particular embodiments, a multi-channel automatic speech recognition (ASR) system may use directional information to identify and eliminate cross-talking speech signals and transcribe only the speech signals coming from the user wearing a head-mounted device (e.g., smart glasses) and/or a target person the user is having a conversation with. The multi-channel ASR system may rely on speech signals coming from different directions that are captured by multiple microphones of the head-mounted device. The multi-channel ASR system may use spatial filters (e.g., the beamformer) to attenuate sounds from other directions but the target direction. Instead of using a single target direction, the multi-channel ASR system may apply such spatial filters for multiple target directions and provide multiple of such outputs to an ASR model. In particular embodiments, the multi-channel ASR system may perform beamforming on the speech signals into multiple directions simultaneously. The beamformed audio outputs may be then provided to an ASR model, which uses the beamformed audio outputs to disambiguate speech from different directions. The multi-channel ASR system may determine which person the user is talking with and filter out any crosstalk, thus only transcribing that person and the user themselves. Although this disclosure describes suppressing particular speech signals by particular systems in a particular manner, this disclosure contemplated suppressing any suitable speech signal by any suitable system in any suitable manner. In particular embodiments, a client system 138 associated with a first user may receive, at the client system 138, a plurality of speech signals captured by a plurality of microphones of the client system 138. The plurality of speech signals may comprise one or more cross-talking speech signals in addition to general background noise. In particular embodiments, the client system 138 may generate, based on applying spatial filtering steered to a plurality of directions to the plurality of speech signals, directional data for the plurality of speech signals. The directional data may comprise output from the spatial filtering for the plurality of directions. The client system 138 may then identify, based on the directional data by one or more machine-learning models, one or more target speech signals and the one or more cross-talking speech signals from the plurality of speech signals. In particular embodiments, the client system 138 may generate one or more transcriptions for the one or more target speech signals. The client system 138 may further present, at the client system 138, one or more of the transcriptions to the first user.

Introduction

With advances in mobile computing, smart glasses are becoming powerful enough to generate real-time closed captions of live conversations. Such system may need to distinguish speech from the conversation partner from the wearer's, and in public places it should be prevented from transcribing speech from unrelated bystanders to avoid confusion and to honor privacy. The embodiments disclosed herein disclose an end-to-end modeling approach that utilizes the smart glasses' microphone array. But the embodiments disclosed herein go beyond beamforming for improved target-speaker SNR: We feed multiple audio channels to the ASR model as a basis for speaker-attributed transcription and suppression of bystander crosstalk. The disclosed multi-channel directional ASR model may process multiple beamformer outputs for different steering directions simultaneously and combine it with serialized output training. Under room-acoustics and noise simulation, the embodiments disclosed herein demonstrate near perfect (which may constitute a major advancement of the state of the art) wearer/conversation-partner disambiguation and suppression of cross-talking speech from non-target directions. Experiments based on the disclosed embodiments showed remarkable and unexpected levels of noise robustness, which may have been a combination of SNR improvement from beamforming and passing multiple such channels at once to provide additional gain from more “cognitive” type processing by the ASR model.

In particular embodiments, the client system 138 may be a head-mounted device. A user may wear a head-mounted device (e.g., smart glasses) and use such device for live translation. In other words, the one or more target speech signals may be based on a first language whereas the one or more transcriptions may be based on a second language that is different from the first language. Further, the one or more transcriptions may be a translation of the target speech signals from the first language to the second language. Automatically transcribing speech of a conversation partner at a distance of several feet may be an important scenario (e.g., automatic generation of captions for deaf or hard-of-hearing users). This is also a problem not yet satisfactorily solved by the state of the art. Background noise, reverberation, overlapping speech, and interfering speakers make this a challenging task. In particular, during live transcription, if there are multiple people nearby talking, it may be difficult to know which utterance to transcribe. As an example and not by way of limitation, the first user may be in a conversation with one or more second users. The one or more cross-talking speech signals may correspond to one or more utterances from one or more third users. However, the one or more third users may be not in the conversation. In conventional live-transcription systems, when there were multiple people speaking, these systems may try to distinguish different speakers and transcribe all incoming speech signals. However, such approach may lead to the transcription getting corrupted with crosstalk from other speakers, making the transcription read like gibberish.

As a remedy, one may capture the speech with a microphone array (in a sense, that's what humans may do) and perform binaural processing. Humans do not do beamforming based on binaural input (humans only beamform by means of the shape of the pinna). Instead, the “beamforming” effect is by means of cognitive processing and simultaneously matching patterns across both audio inputs. The embodiments disclosed herein may capture this cognitive processing, in addition to the beamforming. Microphone-array methods may often aim to improve the SNR of target speech. The embodiments disclosed herein demonstrate how multi-channel audio may also be used more directly, for speaker disambiguation and crosstalk suppression.

Literature roughly divides microphone-array based ASR into two categories: end-to-end approaches and hybrid approaches. In the end-to-end approaches [Refs. 1, 2, 3, 4, 5], the multi-channel ASR model is optimized only via an ASR criterion with or without explicit separation modules. MIMO-speech [Ref. 4] is a multichannel end-to-end neural network that defines source-specific time-frequency (T-F) masks as latent variables in the network, which in turn are used to transcribe the individual sources. In [Ref. 5], MIMO-speech is further improved by incorporating an explicit localization sub-network. Recent studies [Refs. 6, 7] in ASR and speaker separation have also investigated directly incorporating spatial features instead of using explicit sub-modules jointly trained with the ASR module. For instance, [Ref. 7] proposes an “all-in-one”model where the 3D spatial feature is directly used as input to the ASR system without explicit separation modules.

Hybrid methods typically employ a pipeline-based paradigm, where a speech separation module precedes the back-end ASR system that explicitly separates the clean target speech or explicitly predicts speaker related masks [Refs. 7, 8, 9, 10, 11]. For example, Chen et al. [Ref. 8] proposed a method for estimating a target speaker mask with multi-aspect features that can extract the target speaker from a speech mixture. The extracted speech signal is then fed into an ASR system.

However, such end-to-end and hybrid approaches for multichannel ASR may involve explicit speaker separation or masking, before inputs are fed input into the ASR system, or concatenating the spatial cues with the ASR features. In contrast, the embodiments disclosed herein may utilize multiple beamformer outputs (e.g., based on a variety of beamformer algorithms such as super-directive beamforming) for different steering directions, which may be processed simultaneously by a single ASR encoder. This may allow the system to perform speech separation and suppression implicitly, by using directional information, effectively learning to compare the different beamformer outputs. As a result, one technical advantage may be that this method does not use explicitly extracted speaker characteristics.

In particular embodiments, a head-mounted device (e.g., smart glasses) may have a plurality of microphones. The plurality of microphones may be configured to capture speech signals from multiple directions based on beamforming. In particular embodiments, one or more first microphones of the plurality of microphones may be aligned along a cartesian plane. One or more second microphones of the plurality of microphones may be aligned along an apical axis. As an example and not by way of limitation, there could be seven microphones with five aligned along the x-y plane and two aligned along the z-axis.

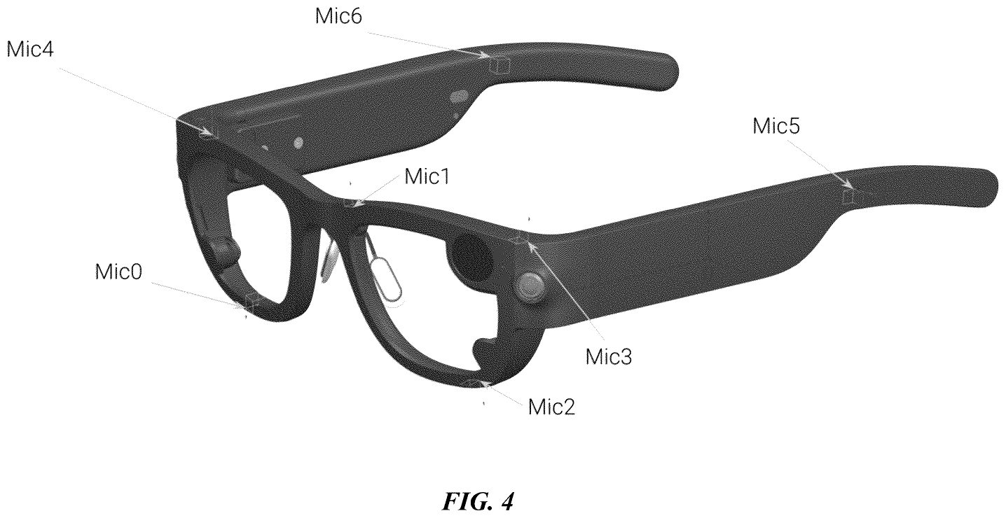

The microphone array in the embodiments disclosed herein may be included on smart glasses with a broad range of sensors for ego-centric smart-glasses applications. See, for example, [Ref. 12]. FIG. 4 illustrates example microphone locations on smart glasses. The microphone array may comprise 7 channels (e.g., Mic0-Mic6) as shown in FIG. 4.

In particular embodiments, these microphones may allow the head-mounted device to determine the directions various input speech signals are coming from. With these microphones, a solution to the cross-talking problem may be using directional information to identify which speech signal is crosstalk, allowing the system to transcribe only the speech signals coming from the person the user of the head-mounted device is having a conversation with (i.e., the “target person”). In particular embodiments, the spatial/directional information may be utilized by the multi-channel ASR system, which may then be used to ignore undesired signals. As an example and not by way of limitation, for live transcription in AR glasses, distractor speech (crosstalk from unrelated bystanders captured by the microphones), may be suppressed in order to avoid interferences in the transcriptions (and to preserve privacy). The spatial information inferred from multi-mic data may assist with suppressing the crosstalk. As a result, the embodiments disclosed herein may have a technical advantage of effectively generating speaker-attributed transcription while simultaneously suppressing bystander crosstalk as the multi-channel ASR system may use an end-to-end modeling approach that utilizes the smart glasses' microphone array to get directional information of speech signals.

Multi-channel Directional ASR

To begin with, the multi-channel ASR system may get speech signals from different directions. In particular embodiments, the client system 138 may generate directional data associated with the plurality of speech signals. Instead of feeding the raw audio channels into an ASR model, the multi-channel ASR system may use beamforming to generate multi-channel input data first. Thus, the directional data may include the output from the beamforming signal processing algorithm for multiple directions. In particular embodiments, generating the directional data based on the beamforming signal processing algorithm may comprise mapping temporal differences associated with the plurality of speech signals to intensity differences and inputting the intensity differences to the multi-channel ASR model. The multi-channel ASR system may then extract log-Mel features for each direction and integrate them together. Some conventional methods and systems may extract log-Mel features directly from the captured microphone channels. However, such conventional approach may not work well because log-Mel processing removes the most important clue, i.e., the information that represents differences of arrival delays. The embodiments disclosed herein may solve this issue by the beamforming step which converts the temporal differences to intensity differences. In particular embodiments, the client system 138 may extract, for each of the plurality of directions, one or more acoustic (e.g., log-Mel) features for one or more of the plurality of speech signals associated with the respective direction. The client system 138 may further integrate the extracted log-Mel features for each of the plurality of directions.

The multi-channel ASR system may then use a multi-channel ASR model to process the integrated features. The multi-channel ASR system may implicitly determine which speech signal is received from the user direction and which person the user is talking to, and only transcribe these speech signals. In particular embodiments, the client system 138 may identify, based on an analysis of the integrated features by a multi-channel automatic-speech-recognition (ASR) model, one or more speech signals corresponding to one or more utterances from the first user. The client system 138 may also identify, based on an analysis of the integrated features by a multi-channel automatic-speech-recognition (ASR) model, the one or more target speech signals from among the plurality of speech signals as corresponding to one or more utterances from one or more second users. The one or more second users may be in a conversation with the first user. In particular embodiments, the client system 138 may additionally identify, based on an analysis of the integrated features by a multi-channel automatic-speech-recognition (ASR) model, the one or more cross-talking speech signals from among the plurality of speech signals. In particular embodiments, generating the directional data may be based on relative phase and intensity differences between the plurality of microphones.

In particular embodiments, the client system 138 may generate one or more translations for one or more speech signals corresponding to one or more utterances from the first user. The presented one or more transcriptions may be of the one or more translations. Because different speakers speak different languages, the directionality may also help transcribe the correct language (which otherwise would cause severe ASR errors). In particular embodiments, the one or more transcriptions may comprise one or more of an image file of a text transcription of the one or more target speech signals or an audio file of a text-to-speech conversion of the text transcription. As an example and not by way of limitation, the transcriptions may be presented to the first user as text on a screen display of the head-mounted device. As another example and not by way of limitation, the transcriptions may be read out to the first user as audio transcriptions.

In particular embodiments, the multi-channel ASR system may be used in other scenarios as follows. In once scenario, instead of head-mounted devices (e.g., smart glasses) with a microphone array, multiple users in a room may put their smartphones on the table, and the input to the multi-channel ASR system may include all audio signals from these microphones. Some users may have earphones instead. Instead of applying a beamformer on these inputs, the audio streams from the multiple distributed microphones themselves may act like the beamformed signals that constitute the multi-channel input to the ASR model. In another scenario, the microphone array of a head-mounted device (e.g., smart glasses) may get replaced by a mobile phone that has multiple microphones.

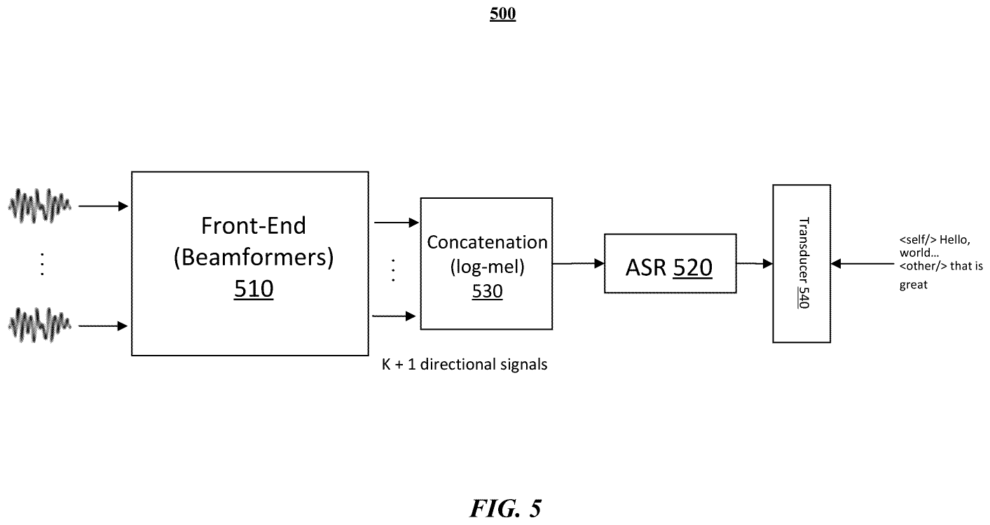

FIG. 5 illustrates an example architecture 500 of directional speech recognition. It may comprise a front-end 510 with multiple super-directive beamformers followed by an ASR module 520. The ASR module 520 may receive multiple input streams and may be trained via serialized output training [Refs. 13, 14] to detect speech from different directions. Unlike a standard single-channel ASR system, the multi-channel directional ASR system may utilize the differences in the directional outputs from the beamformers, allowing it to classify and separate speech signals arriving from different directions. The multi-channel directional ASR system may be an effective solution for addressing the technical challenge of classifying and separating speech signals arriving from different directions.

A straight-forward way may be to feed all microphones' raw audio into N parallel front-end 510, hoping that the model may automatically learn to separate speech from different directions. This, however, may not work. The usual ASR feature extractors may remove phase information, but temporal differences may be the most important information for detecting direction of arrival. Instead, in the embodiments disclosed herein, we may pre-process the raw multi-channel audio by beamforming it for K steering directions around the smart-glasses device plus one in the speaker's mouth direction. As an example and not by way of limitation, the steering directions may be horizontal. However, the steering directions may be any suitable directions. For instance, we may find that users raise or lower their head to look at a transcription display, so that we may include tilted planes. In particular embodiments, generating the directional data may be based on a beamforming signal processing algorithm. These beamformers may use predetermined coefficients. The ASR feature extraction front-end 510 may be then applied to these K+1 beamformed channels, the output of which may be concatenated by a concatenation module 530 and fed into the ASR 520 encoder neural network. This may map the problem from comparing phase differences to one of comparing magnitudes and feature characteristics derived from different steering directions.

As seen in FIG. 5, the N channels of raw audio data may be fed into the beamformer front-end 510, which may then obtain the K+1 directional signals. We may then extract the usual log-Mel features for each beamformer direction and concatenate them together. This concatenated vector may constitute the input of the ASR 520 encoder.

The beamformers used in the embodiments disclosed herein may include super-directive beamformers [Refs. 15, 16, 17]. A super-directive beamformer may be derived by maximizing the directivity factor, or DF. Specifically, the method may minimize the power output and apply a linear constraint in order to obtain an undistorted output signal. This optimization may maximize the directivity index. The K+1 beamformers may be predetermined. At runtime they may be realized via one-dimensional convolutions or via frequency-domain processing.

Our ASR model 520 may be a Neural Transducer [Refs. 18, 19, 20, 21]. This well-known end-to-end ASR architecture may comprise three components: an encoder, a prediction network, and a joiner network. The goal of the transducer model 540 is to produce a label sequence Y=(y₁, . . . , y_{L}) of length L, which may be a sequence of words or word-pieces, from an input sequence X=(x₁, . . . , x_{N}) of length N typically received in real time, typically a sequence of acoustic features like Mel-spectral energies. As an example and not by way of limitation, the sequence of words or word-pieces may be “<self/> Hello, world . . . <other/> that is great” as illustrated in FIG. 5. The encoder neural network may process the input sequence X and produce a sequence of acoustic representations, denoted as h^{enc}=(h₁^{enc}, . . . , h_{T}^{enc}), of length T, which might differ from N due to sub-sampling. The prediction neural network may act as an internal language model or decoder to generate a representation hᵤ^{dec}, where u represents the decoder state. Generally, u may depend on the previous output labels y_{0:l-1}=(y₀, . . . , yₗ₋₁), where y₀ corresponds to a start of sentence symbol, and l denotes the label index. Lastly, the joiner network may take the output representations from the encoder and prediction network as in-put and create the joint representation h_{t,u}^{joint}, where t denotes the encoder frame index.

What sets our model apart may be that we also incorporate serialized output training, or SOT [Refs. 13, 14]. This is a technique for detecting speaker changes—in our case between the wearer and a target speaker (other)—as well as for recognizing partially overlapping speech. In our SOT implementation, ground-truth transcriptions from multiple speakers may be sorted by the end times of all words. These are then interleaved, where at every speaker change, a special symbol may be inserted. This way, the model may learn to intersperse ASR transcripts with markup to indicate whether the speech came from self (the wearer of the glasses) or from other (the conversational partner opposite to the wearer). Note that compared to [Refs. 13, 14], the availability of multiple input channels as disclosed in the embodiments herein specifically aim to achieve performing this task significantly easier. Incorporating serialized output training when training the ASR model has shown to be an effective solution for addressing the technical challenge of detecting speaker changes between a wearer of the head-mounted device and a target speaker, as the serialized output training may enable the model to learn to intersperse ASR transcripts with markup to indicate whether the speech came from self (the wearer) or from other (the conversational partner opposite to the wearer).

More importantly, what sets our model apart may be also that we feed it with multiple beamformer outputs such that it may better distinguish speech from multiple directions, even when the spatial filtering (done by the beamformer) is not capable to remove speech from unwanted directions sufficiently. The ASR model may leverage the differences between the beamformer outputs to distinguish the target speech from the rest. This is different from other solutions, that typically may only use a single beamformer output steered towards a target speaker only. If multiple speakers are present, such systems may typically also recognize them one after another or in parallel by feeding different beamformer outputs to different ASR streams.

In particular embodiments, the first user may be in a conversation with one or more second users. Correspondingly, the client system 138 may detect a change from the first user speaking to one of the one or more second users speaking. The client system 138 may further determine one or more second target speech signals of the target speech signals subsequent to the detected change correspond to one or more second utterances from the one of the second users. Accordingly, the one or more transcriptions may comprise one or more second transcriptions for the one or more second target speech signals. In addition, the one or more of the transcriptions presented to the first user may comprise the one or more second transcriptions.

In particular embodiments, the first user may be in a conversation with one or more second users. The plurality of speech signals may comprise one or more first speech signals corresponding to one or more first utterances from the first user. The plurality of speech signals may comprise one or more second speech signals corresponding to one or more second utterances from one or more of the second users. In particular embodiments, one or more of the first speech signals may overlap with one or more of the second speech signals. The one or more target speech signals may comprise the one or more of the second speech signals overlapping with the one or more of the first speech signals.

Lastly, our model learns to suppress bystanders' speech: The ground truth for training the multi-channel ASR model may include only the transcripts of the self and other speakers. Speech of bystanders, that is, speech simulated from directions other than the target-speaker directions, may be included in the training data as well, but with empty transcripts. This way, the model may learn to ignore crosstalk. Experiments shows that this simple approach works with almost perfect accuracy.

Like [Ref. 18], the embodiments disclosed herein used the alignment-restricted RNN-T (AR-RNN-T) loss, which utilizes prior alignment information, such as forced alignment information from a traditional hybrid acoustic model, to limit the set of alignments to a valid subset. This may result in significant improvements of memory usage and training speed.

Training Multi-Channel Audio Processing Models

In particular embodiments, the multi-channel ASR system may comprise a plurality of multi-channel audio processing models (e.g., ASR, speech enhancement, etc.). Training these models may require a large number of training audio samples. In particular embodiments, data collection and simulation may be two different ways to obtain training data. While data collection may generate real data that leads to better models in practice, simulation may be a cheaper and more scalable solution, and may be the only feasible option.

As discussed previously, head-mounted devices (e.g., AR glasses) may have multiple microphones. To build the multi-channel ASR system based on these microphones, one may need large-scale data. However, such large-scale data may be difficult to collect, given the many variables and permutations involved, such as different microphone configurations for devices or differences in speaker/distractor direction, distance, and positions, etc. Thus, the embodiments disclosed herein created a multi-channel data simulation framework to generate such data.

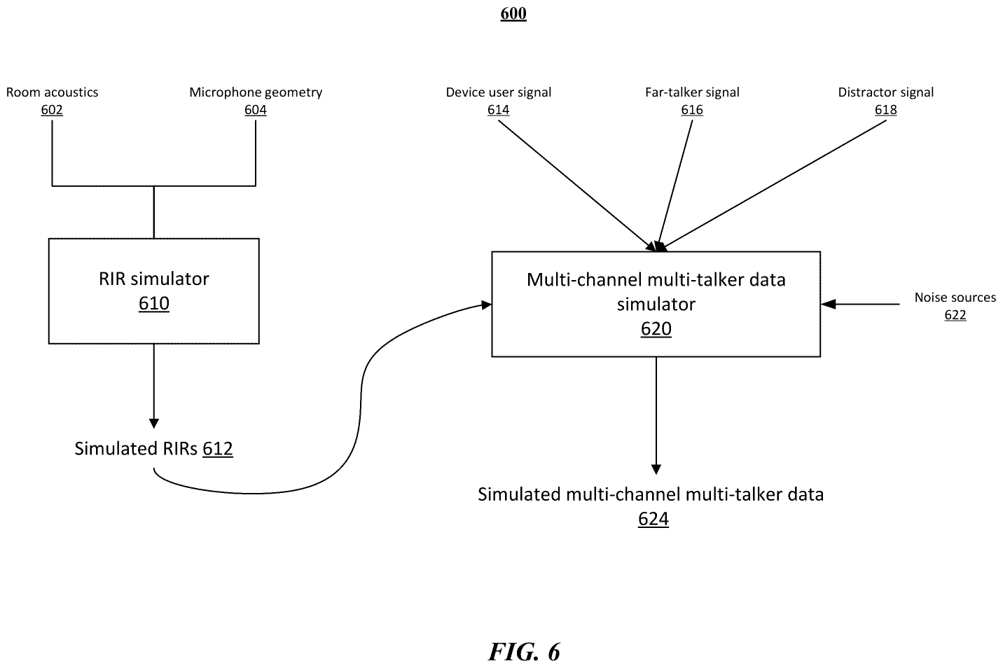

FIG. 6 illustrates an example data simulation diagram 600. In particular embodiments, the simulation framework may comprise two major components: room impulse response (RIR) simulator 610 and multi-channel multi-talker data simulator 620. In particular embodiments, the RIR simulator 610 may take room acoustics 602 such as room size as input and all other things that are randomly generated. The process for each RIR simulator 610 may be as follows. The RIR simulator 610 may randomly sample a head position in the room. As an example and not by way of limitation, one may set a limit for z-axis to be in [0, 2] meters and get the whole microphone geometry information 604 in terms of mic-geometry. The RIR simulator 610 may then randomly sample conversation partner (target person) sources, mouth locations (user themselves), distractor locations and noise sources in terms of a distribution. The distribution may be configurable by the corresponding arguments. The RIR simulator 610 may then calculate a parameter in terms of room size. The RIR simulator 610 may further compute RIRs and save simulated RIRs 612. The simulated RIRs 612 may be provided to the multi-channel multi-talker data simulator 620.

In particular embodiments, the multi-channel multi-talker data simulator 620 may additionally take device user signal 614, far-talker signal 616, distractor signal 618, and noise sources 622 to generate the simulated multi-channel multi-talker data 624. As an example and not by way of limitation, the simulated multi-channel multi-talker data may comprise conversation audio, far-end audio reference, near-end audio reference, transcripts for the conversation, and meta information (e.g., source locations).

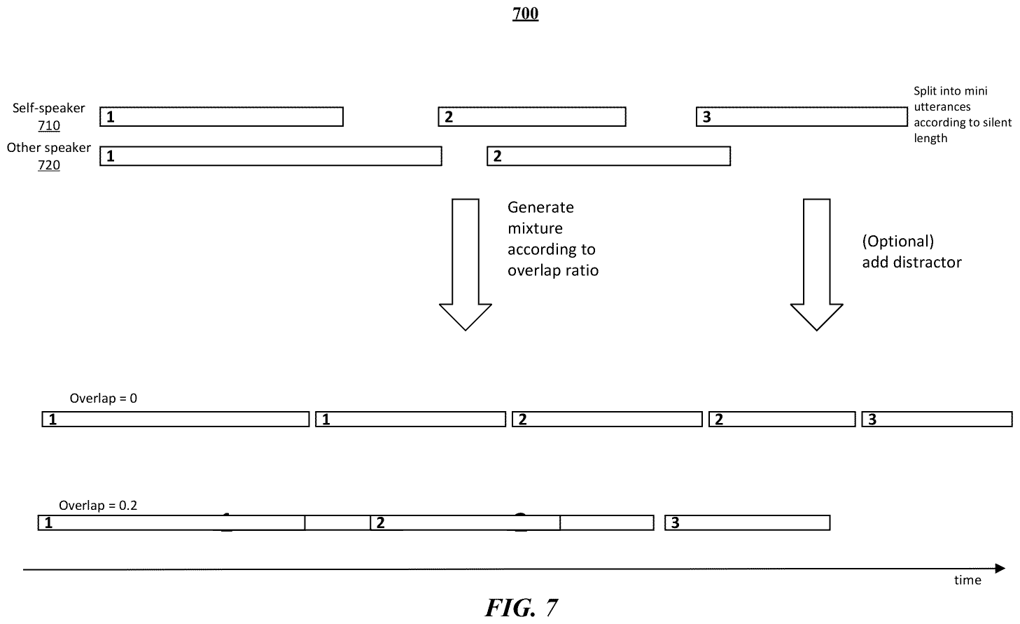

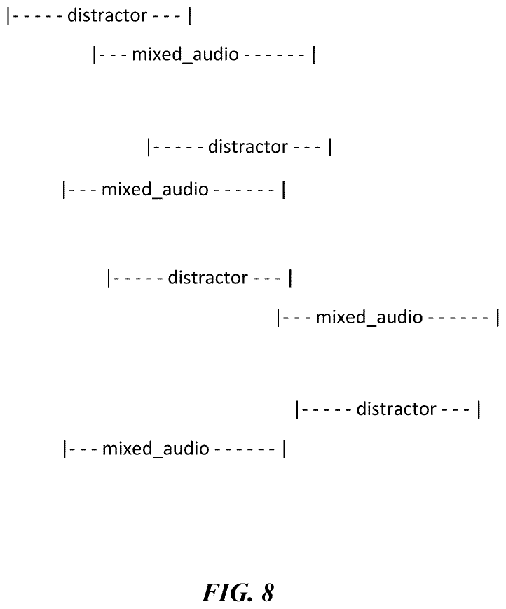

FIG. 7 illustrates an example process 700 for multi-talker simulation. In the multi-talker simulation, one may assume there are 1-3 speakers as an example: self-speaker 710, other speaker 720 and distractor. One may first split one or more utterances into several mini utterances in terms of silent length. Then, we may mimic the conversation by concatenating these small segments. We may also provide an overlap ratio argument to control how we merge these segments. The multi-talker simulation may also take the transcription and word alignments from self/other as input, and then it may sort the output transcription and word alignments by end-time and insert a speaker change token “»” with an optional speaker tag when two consecutive words are from different speakers. In the live transcription scenario, we may use “»0” to represent SELF and “»1” to represent OTHER. Adding the distractor or not may be also configurable. In particular embodiments, the distractor may be added as a single audio that can overlap with the mixed audio. FIG. 8 illustrates examples of adding distractor to the simulation. In particular embodiments, one may simply ignore the transcription from the distractor.

In particular embodiments, the multi-channel data preparation pipeline may be implemented as a data augmentation transformer. This transformer may take in a configuration file that contains a list of front-end augmentation transformers. These front-end transformers may be composed in a pipeline, one after the another, to create a complete data preparation pipeline.

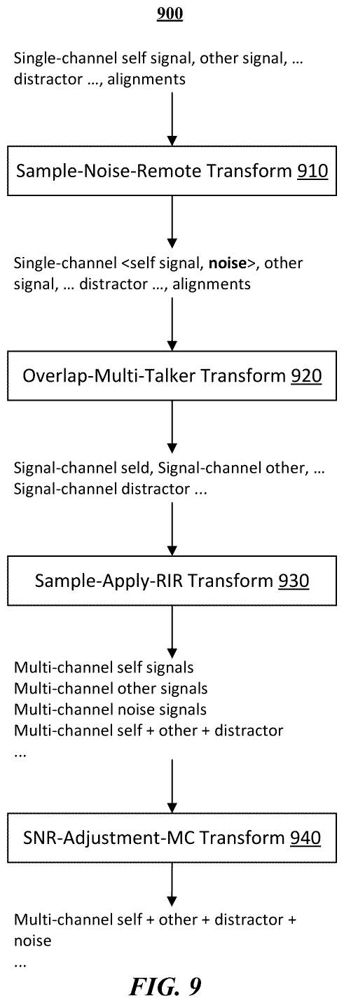

FIG. 9 illustrates an example pipeline 900 for multi-channel data simulation. In particular embodiments, the multi-channel ASR system may use four transforms to generate the noisy multi-channel data. The embodiments disclosed herein assume that we have device user (SELF) signals, conversation partner (OTHER) signal, distractor signal and noise signal when simulating the conversation scenario. All of them may be single-channel signals.

In particular embodiments, sample-noise-remote transform 910 may take a desired number of noise datasets and randomly samples noise signals to be added to the raw speech signal. The noise sources may be kept as separate arrays in a list next to the raw speech signal. Overlap-multi-talker transform 920 may allow us to simulate multi talker scenarios for multi-channel speech. When simulating the multi-talker scenario, alignment information may be used to make speech sound naturally in terms of the phone or word at the boundary when cutting into small segments. Sample-apply-RIR transform 930 may be used to sample the RIR and then apply the RIR to the clean and noise sources. It may accept multiple RIR datasets, which means one may use the RIR generated by RIR simulator and real RIR recording if we have. SNR-adjustment-MC transform 940 may randomly select a target output level and SNR level and mix the noise sources with the raw speech signal to generate the final noisy mixture. It may also control if adding distractors and their volume.

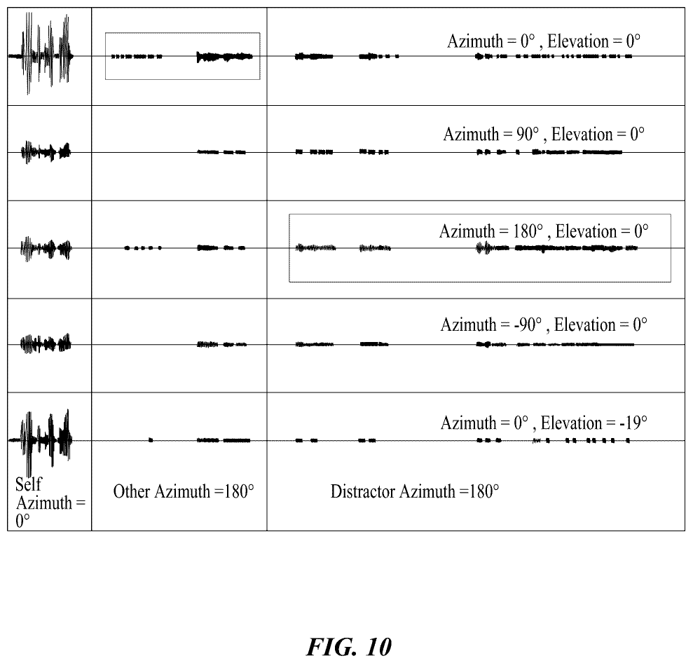

FIG. 10 illustrates an example simulation of 7-channel data associated with AR glasses. The embodiments disclosed herein may use a beamforming signal processing algorithm to verify the simulated data. The audio example in FIG. 10 was processed by the beamforming signal processing algorithm. The input of the beamforming signal processing algorithm may comprise 7 raw channel simulated audio and the output may comprise the 5 directional signals. For example, “Azimuth=0°, Elevation=0°” means 12 o'clock direction. In FIG. 10, the other speaker is at 12 o'clock and the distractor is at 6 o'clock. It may be seen that the energy of the other and distractor are stronger in their corresponding direction than other directions.

### Experiments and Results

The embodiments disclosed herein conducted experiments using two datasets: the open-source Librispeech corpus [Ref. 22], which consists of 960 hours of speech from audiobooks in the LibriVox project, and an in-house dataset of de-identified video data publicly shared one-line users. The training and evaluation sets of the in-house video data consist of 40k and 50 hours, respectively. The experiments show that the multi-channel ASR system is effective in suppressing crosstalk.

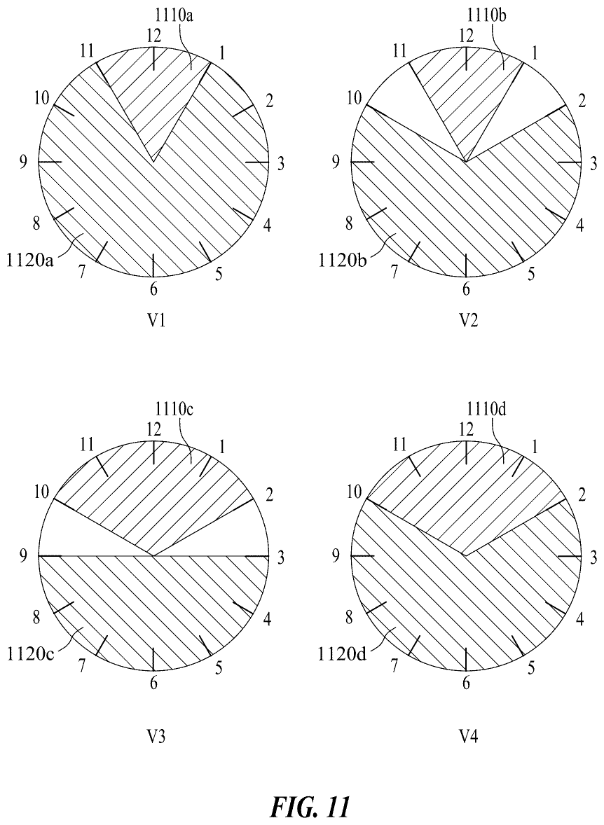

To simulate the training data, the embodiments disclosed herein generated 100,000 multichannel room impulse responses (RIRs) for rooms with sizes ranging from [Refs. 5, 5, 2] to [Refs. 10, 10, 6] meters. The embodiments disclosed herein used the geometry of the smart glasses illustrated in FIG. 4 to simulate multi-channel data, which has 7 microphones. The embodiments disclosed herein generated the multi-channel signals using image-source methods (ISM)[Ref. 23]. To better understand the impact of crosstalk on speech recognition, the embodiments disclosed herein generated four different training sets varying the locations of conversation partners and bystanders. FIG. 11 illustrates example training configuration of spatial positions of the conversation partner and bystander. Areas 1110a-1110d represent the partner areas, while areas 1120a-1120d represent the bystander areas. In the V1 configuration, the conversation partners are located between 1 and 11 o'clock (partner area 1110a), and bystanders are located between 1 and 11 o'clock (bystander area 1120a). The V2 and V3 settings leave a gap between the simulated partner and bystander directions. This is to study whether very close bystander and partner directions, such as in V1 and V4, might confuse the model during training due insufficient spatial resolution of the array.

The baseline systems used for performance comparison are a single-channel ASR system and an inter-channel phase differences (IPDs) system. The single-channel system may take the reference microphone signals (the first microphone) as input. IPDs [Refs. 24, 6] may be calculated as follows

IPD_{t,f}⁽ⁿ⁾=∠Y_{t,f}ⁿ^{₁}−∠Y_{t,f}ⁿ^{₂}

where ∠Y_{t,f}ⁿ^{₁} denotes the angle of the complex representation ∠Y_{t,f}ⁿ^{₁} with t and f representing time and frequency and (n) is the index for the microphone pairs. The substation of the phase signals for a pair of microphone signal, including a target and a reference microphone, may eliminate phase variations inherent in source signals and hence allow room acoustic characteristics to be directly captured. The IPD features may be further augmented with magnitude spectra to leverage both spectral and spatial cues. For the short-term Fourier transform, we may use a Hanning windows of 16 ms and a frame shift of 10 ms. 6 pairs of microphones may be selected for IPD, which may be (0,1), (0,2), (0,3), (0,4), (0,5), (0,6). The total dimension of the input feature after concatenation may be 129*(7+6)=1677.

The baseline systems and the disclosed systems herein are using the same model architecture, except for a different input dimension. For each beamformer direction or raw microphone channel, we extracted 80-dimensional log-Mel filter-bank features. Input features from multiple directions or channels are concatenated. The encoder network's input layer projects this resulting concatenated feature vector to 128 dimensions. Then, four consecutive frames are stacked to form a 512-dimensional vector (reducing the sequence length by 4×). This is followed by 20 Emformer blocks [Ref. 25] with 8 attention heads and 2048-dimensional feed-forward layers. The RNN-T's prediction network contains three 512-dimensional LSTM layers with layer normalization and dropout. Lastly, the encoder and predictor outputs are both projected to 1024 dimensions and passed to an additive joiner network, which contains a linear layer with 4096 output BPE units.

We use an Adam optimizer with a tri-stage learning-rate scheduler. For LibriSpeech, models are trained for 120 epochs, with a base learning rate of 0.001, a warmup of 10,000 iterations, and forced annealing after 60 epochs. For experiments on large-scale in-house data, a similar model architecture and training hyper-parameters were used, with training for 15 epochs.

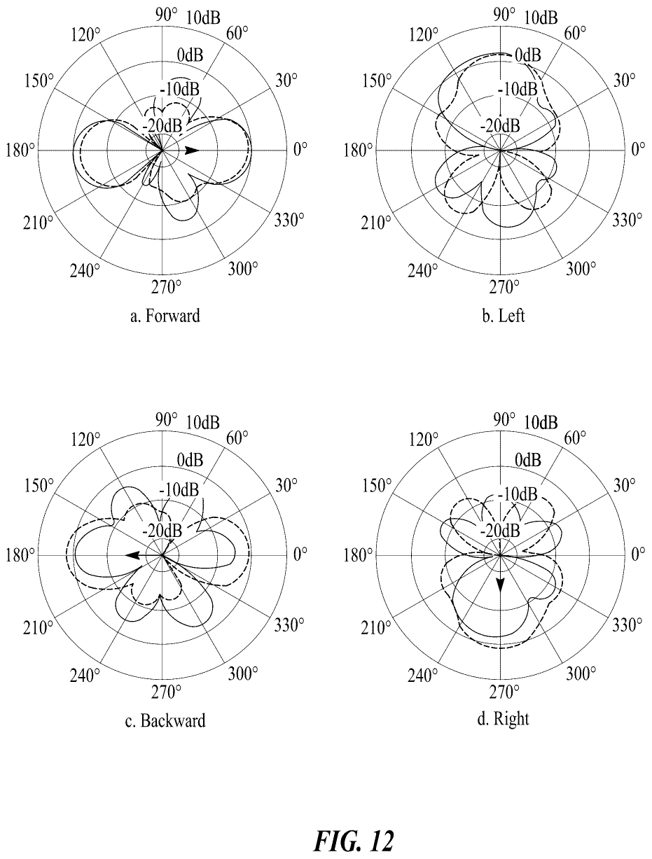

FIG. 12 illustrates example beam patterns of the super-directive beamformer at frequency of 2 kHz. The beam patterns are for 4 different directions, as indicated by the arrows. While beam patterns vary greatly, the gain is 1 in the desired looking directions.

The embodiments disclosed herein compare the disclosed multi-channel directional ASR system (referred to as “D-ASR”) with two baselines. The number of beams used in the ASR model, K+1, was represented by the numbers in brackets after “D-ASR”-[D-ASR-1], [D-ASR-5], and [D-ASR-13]. These numbers denote the number of beams used in the ASR model, with “1” indicating beamformed output at 12 o'clock direction, “5” representing 4 beams for the horizontal plane (at 90-degree increments) plus the self-beam (to the wearer's mouth), and “13” representing 12 beams for the horizontal plane at 30-degree increments plus the self-beam.

Unless otherwise noted, word error rates (WERs) consider speaker attribution by counting self and other tags like words. A missing or incorrect speaker tag counts as one error.

First, Table 1 shows that the single beamformed input system (D-ASR-1) outperforms the single-channel reference-microphone system (SC-Raw mic) in most cases, by significant margins. In other words, using a single directional signal may already provide valuable spatial cues. Compared with the strong IPD baseline systems, which uses explicit spatial cues, our proposed D-ASR with 5 directional signals consistently achieves better performance, demonstrating the effectiveness of our approach.

TABLE 1
WERs (%) for the proposed and baseline systems on Librispeech. C1: bystanders
are located at 3 to 5 o'clock and 7 to 9 o'clock. C2: bystanders are
located at 10 o'clock and 2 o'clock. C3: bystanders are located at 5
o'clock and 7 o'clock. Annotation is same to other tables. The overlap ratio is 0%.

| | Partner [12] | | | Partner [11/1] | | | Partner [10/2] | | |
|---|---|---|---|---|---|---|---|---|---|
| Model | C1 | C2 | C3 | C1 | C2 | C3 | C1 | C2 | C3 |
| D-ASR-5 (V1) | 12.0 | 12.9 | 11.9 | 14.7 | 15.2 | 14.9 | 52.5 | 53.2 | 52.4 |
| D-ASR-5 (V2) | 12.0 | 13.8 | 12.0 | 14.7 | 16.1 | 14.7 | 52.7 | 53.9 | 52.6 |
| D-ASR-5 (V3) | 12.0 | 49.8 | 12.0 | 14.2 | 51.9 | 13.9 | 14.5 | 51.9 | 14.5 |
| D-ASR-5 (V4) | 12.0 | 36.8 | 12.0 | 14.2 | 38.5 | 14.1 | 15.4 | 43.8 | 15.2 |
| IPD (V1) | 15.0 | 15.7 | 14.7 | 15.9 | 16.4 | 16.1 | 53.8 | 54.3 | 53.8 |
| IPD (V2) | 14.9 | 16.8 | 14.7 | 15.2 | 16.8 | 15.3 | 53.7 | 54.8 | 53.7 |
| IPD (V3) | 15.1 | 55.5 | 14.9 | 15.3 | 54.6 | 15.1 | 15.6 | 54.9 | 15.7 |
| D-ASR-1 (V1) | 16.5 | 26.2 | 17.1 | 20.6 | 30.2 | 21.8 | 29.0 | 39.5 | 30.1 |
| D-ASR-1 (V2) | 17.2 | 29.0 | 16.3 | 19.7 | 31.5 | 20.6 | 28.3 | 41.4 | 28.7 |
| D-ASR-1 (V3) | 18.3 | 41.1 | 16.7 | 21.7 | 43.4 | 20.0 | 25.1 | 46.6 | 22.9 |
| SC-Raw mic (V1) | 41.3 | 42.1 | 40.9 | 40.9 | 41.6 | 42.1 | 41.3 | 41.1 | 40.9 |
| SC-Raw mic (V2) | 40.9 | 42.2 | 40.4 | 40.8 | 40.9 | 41.3 | 40.5 | 40.9 | 40.7 |
| SC-Raw mic (V3) | 41.5 | 43.0 | 40.8 | 42.0 | 42.3 | 42.4 | 41.8 | 41.9 | 41.3 |

The embodiments disclosed herein also compare training conditions for different bystander locations. D-ASR may be sensitive to unseen test conditions, similar to IPD-based methods. As an example and not by way of limitation, the performance of D-ASR-5 with V3 training data drops significantly for the partner at 12 o'clock when bystanders are nearby the 10 and 2 o'clock directions (C2). In the V3 training data, bystanders are only located at 3 to 9 o'clock, so C2 is an unseen condition. In contrast, the V4 training condition also includes bystanders close to the 10 and 2 o'clock directions, which results in improvements over V3, although the discrimination between bystander and partner is very narrow at this location.

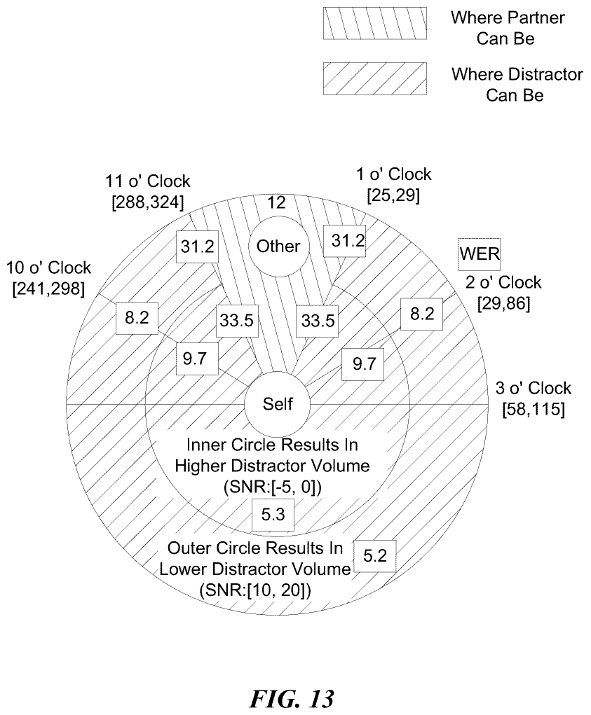

FIG. 13 illustrates an example chart showing our best results. The numbers are word-error rates (WER) for speakers positioned at the respective positions in space. For example, the word-error rate (WER) for speakers positioned between 3 o'clock to 9 o'clock with respect to a user of smart glasses can be as low as 5.2. The WER for speakers positioned between 9 o'clock and 10 o'clock with respect to the user may range from 8.2 to 9.7 depending on how far the speakers are from the user. This is similar for speakers positioned between 2 o'clock and 3 o'clock. The WER for speakers positioned between 10 o'clock and 2 o'clock may be higher, e.g., between 31.2 and 33.5. It may be seen that suppression for distractors from 3 o'clock to 9 o'clock is almost perfect, regardless of their volume. For distractors in the upper circle, we may begin to see accuracy impact, i.e., the closer the distractor is to OTHER the worse the WER (predominantly due to insertions). Volume may also begin to matter, though not as important as position.

The embodiments disclosed herein conduct ablation studies to measure the impact of the number of beams used for model training. Here, we fixed the model training using V4 configuration. Table 2 contains the results for Librispeech comparing four such systems. Comparing D-ASR-5 with D-ASR-1, we see that more beams may reduce the WER significantly on the conditions that bystanders are far away from the partners (C1 and C3). When bystanders are close to the partner (C2), D-ASR-1 performs somewhat better, likely because the spatial resolution of the beamforming may be not sufficient to resolve bystander and partner directions that are very close. Similar to using 13 beams, we also see an improvement in the C1 and C3 conditions. Applying volume perturbation further boosts ASR performance, which may teach the model to not rely on amplitude differences to discriminate speaker directions but on other special and spectral cues instead.

TABLE 2
The impact of the different number beams for the directional
speech recognition. The overlap ratio is 0%.

| | Partner [1/11] | | |
|---|---|---|---|
| Model | C1 | C2 | C3 |
| D-ASR-1 (V4) | 21.1 | 38.5 | 19.7 |
| D-ASR-5 (V4) | 14.2 | 38.5 | 14.1 |
| D-ASR-13 (V4) | 13.4 | 41.8 | 13.5 |
| D-ASR-13 (V4) + vol. Perturb | 13.3 | 36.7 | 13.2 |

Next, the embodiments disclosed herein investigate the impact of performance under different overlap conditions. As presented in Table 3, we initially validated the performance of our D-ASR model under ideal conditions, i.e., no noise and crosstalk, in which it achieved around 5.5% on Librispeech test-clean dataset in all cases. At 0% overlap, the crosstalk speech increases the total amount of speech by approximately 50%—undesired speech that should not be recognized (with crosstalk disabled, audio length still increases by 50%, but of silence or noise). The single-channel model only suppresses some lower-volume crosstalk, while it decodes its majority as insertion errors, pushing the WERs to over 40%. Whereas the D-ASR model suppresses crosstalk almost perfectly at the lower overlap ratios: At 0% overlap, the WER increases from 12.2 to 12.8%, 0.6% absolute, corresponds to only about 1.2% of the crosstalk audio. Accuracy degrades a bit more at 100% overlap, when bystander speech effectively becomes background noise.

TABLE 3
WER (%) at varying ratios of overlap
of cross-talk with self/other speech.

| | | | | Partner [1/11] | |
|---|---|---|---|---|---|
| Model | Over- lap | Noise | Cross- talk | C1 | C3 |
| SC-Raw (V1) | 0% | Y | Y | 40.9 | 42.1 |
| D-ASR-13 (V4) | 0% | N | N | 5.5 | 5.5 |
| | | Y | N | 12.2 | 12.5 |
| | | Y | Y | 12.8 | 13.0 |
| D-ASR-13 (V4) | 50% | N | N | 5.5 | 5.5 |
| | | Y | N | 13.2 | 12.9 |
| | | Y | Y | 14.2 | 14.0 |
| D-ASR-13 (V4) | 100% | N | N | 5.6 | 5.6 |
| | | Y | N | 14.1 | 14.3 |
| | | Y | Y | 16.0 | 15.9 |

The embodiments disclosed herein further use the D-ASR-13 (v4) 0% no crosstalk C3 configuration to look at speaker-attribution accuracy. We split ASR output/ground truth by speaker tags. Now, words attributed to the wrong speaker become insertions or deletions. After this split, the resulting WER increases from 12.5% to 12.7%. Hence, speaker attribution may work almost perfectly as well.

TABLE 4
WER (%) on our in-house data, at overlap ratio 0%

| | Partner [12] | | | Partner [11/1] | | |
|---|---|---|---|---|---|---|
| Model | C1 | C2 | C3 | C1 | C2 | C3 |
| D-ASR-5 (V1) | 11.0 | 11.0 | 11.0 | 12.8 | 13.1 | 12.5 |
| D-ASR-5 (V2) | 10.8 | 11.3 | 10.8 | 11.1 | 11.5 | 11.1 |
| D-ASR-5 (V3) | 11.1 | 56.7 | 11.1 | 11.1 | 59.9 | 11.1 |
| IPD (V1) | — | — | — | 22.2 | 23.0 | 22.2 |
| IPD (V2) | — | — | — | 22.3 | 23.6 | 22.2 |
| IPD (V3) | — | — | — | 22.2 | 69.5 | 22.1 |

Finally, the embodiments disclosed herein conduct experiments on our large-scale in-house dataset. As shown in Table 4, we observed similar tendency on the in-house data. The disclosed multi-channel directional ASR model consistently outperforms the IPD baseline system in all cases.

### CONCLUSIONS

This disclosure disclosed an ASR modeling approach that uses multi-channel directional input. Besides the usual SNR improvement, multiple audio channels corresponding to multiple beamformer directions may be utilized simultaneously by a single ASR model to distinguish and recognize multiple speakers from different directions and to reliably suppress crosstalk. With this disclosure, our RNN-T based model may be trained to annotate speaker changes and ignore bystander speech in an end-to-end fashion. Comprehensive experiments were conducted for conversational ASR with smart glasses using different bystander and conversational partner conditions. The embodiments disclosed herein have demonstrated that the disclosed multi-channel directional ASR system may disambiguate the wearer's from the conversation partner's speech and suppress bystander speech (from undesired directions) almost perfectly.

### REFERENCES

The following list of references correspond to the citations above:
[1] J. Heymann, L. Drude, C. Boeddeker, P. Hanebrink, and R. Haeb-Umbach, “Beamnet: End-to-end training of a beamformer-supported multi-channel ASR system,” in 2017 IEEE International Conference on Acoustics, Speech and Signal Processing (ICASSP). IEEE, 2017, pp. 5325-5329.
[2] X. Chang, W. Zhang, Y. Qian, J. Le Roux, and S. Watanabe, “End-to-end multi-speaker speech recognition with transformer,” in ICASSP 2020-2020 IEEE International Conference on Acoustics, Speech and Signal Processing (ICASSP). IEEE, 2020, pp. 6134-6138.
[3] T. Ochiai, S. Watanabe, T. Hori, and J. R. Hershey, “Multichannel end-to-end speech recognition,” in International conference on machine learning. PMLR, 2017, pp. 2632-2641.
[4] X. Chang, W. Zhang, Y. Qian, J. Le Roux, and S. Watanabe, “MIMO-speech: End-to-end multi-channel multi-speaker speech recognition,” in 2019 IEEE Automatic Speech Recognition and Understanding Workshop (ASRU). IEEE, 2019, pp. 237-244.
[5] A. S. Subramanian, C. Weng, S. Watanabe, M. Yu, Y. Xu, S.-X. Zhang, and D. Yu, “Directional ASR: A new paradigm for e2e multi-speaker speech recognition with source localization,” in ICASSP 2021-2021 IEEE International Conference on Acoustics, Speech and Signal Processing (ICASSP). IEEE, 2021, pp. 8433-8437.
[6] Z.-Q. Wang, J. Le Roux, and J. R. Hershey, “Multi-channel deep clustering: Discriminative spectral and spatial embeddings for speaker-independent speech separation,” in 2018 IEEE International Conference on Acoustics, Speech and Signal Processing (ICASSP). IEEE, 2018, pp. 1-5.
[7] Y. Shao, S.-X. Zhang, and D. Yu, “Multi-channel multi-speaker ASR using 3D spatial feature,” in ICASSP 2022-2022 IEEE International Conference on Acoustics, Speech and Signal Processing (ICASSP). IEEE, 2022, pp. 6067-6071.
[8] Z. Chen, X. Xiao, T. Yoshioka, H. Erdogan, J. Li, and Y. Gong, “Multi-channel overlapped speech recognition with location guided speech extraction network,” in 2018 IEEE Spoken Language Technology Workshop (SLT). IEEE, 2018, pp. 558-565.
[9] S. Settle, J. Le Roux, T. Hori, S. Watanabe, and J. R. Hershey, “End-to-end multi-speaker speech recognition,” in 2018 IEEE international conference on acoustics, speech and signal processing (ICASSP). IEEE, 2018, pp. 4819-4823.
[10] Z.-Q. Wang, P. Wang, and D. Wang, “Complex spectral mapping for single- and multi-channel speech enhancement and robust ASR,” IEEE/ACM transactions on audio, speech, and language processing, vol. 28, pp. 1778-1787, 2020.
[11] T. Yoshioka, H. Erdogan, Z. Chen, and F. Alleva, “Multi-microphone neural speech separation for far-field multi-talker speech recognition,” in 2018 IEEE International Conference on Acoustics, Speech and Signal Processing (ICASSP). IEEE, 2018, pp. 5739-5743.
[12] https://about.meta.com/realitylabs/projectaria/.
[13] N. Kanda, J. Wu, Y. Wu, X. Xiao, Z. Meng, X. Wang, Y. Gaur, Z. Chen, J. Li, and T. Yoshioka, “Streaming multi-talker ASR with token-level serialized output training,” arXiv preprint arXiv: 2202.00842, 2022.
[14] X. Chang, N. Moritz, T. Hori, S. Watanabe, and J. L. Roux, “Extended graph temporal classification for multi-speaker end-to-end ASR,” in 2022 IEEE International Conference on Acoustics, Speech and Signal Processing (ICASSP), 2022, pp. 7322-7326.
[15] G. W. Elko, S. Gay, and J. Benesty, “Superdirectional microphone arrays,” KLUWER INTERNATIONAL SERIES IN ENGINEERING AND COMPUTER SCIENCE, pp. 181-238, 2000.
[16] G. Huang, J. Benesty, and J. Chen, “Superdirective beamforming based on the krylov matrix,” IEEE/ACM Transactions on Audio, Speech, and Language Processing, vol. 24, no. 12, pp. 2531-2543, 2016.
[17] S. Doclo and M. Moonen, “Superdirective beamforming robust against microphone mismatch,” IEEE Transactions on Audio, Speech, and Language Processing, vol. 15, no. 2, pp. 617-631, 2007.
[18] J. Mahadeokar, Y. Shangguan, D. Le, G. Keren, H. Su, T. Le, C.-F. Yeh, C. Fuegen, and M. L. Seltzer, “Alignment restricted streaming recurrent neural network transducer,” in 2021 IEEE Spoken Language Technology Workshop (SLT). IEEE, 2021, pp. 52-59.
[19] N. Moritz, F. Seide, D. Le, J. Mahadeokar, and C. Fuegen, “An investigation of monotonic transducers for large-scale automatic speech recognition,” arXiv preprint arXiv:2204.08858, 2022.
[20] T. N. Sainath, Y. He, B. Li, A. Narayanan, R. Pang, A. Bruguier, S.-y. Chang, W. Li, R. Alvarez, Z. Chen et al., “A streaming on-device end-to-end model surpassing server-side conventional model quality and latency,” in ICASSP 2020-2020 IEEE International Conference on Acoustics, Speech and Signal Processing (ICASSP). IEEE, 2020, pp. 6059-6063.
[21] J. Li, R. Zhao, Z. Meng, Y. Liu, W. Wei, S. Parthasarathy, V. Mazalov, Z. Wang, L. He, S. Zhao et al., “Developing rnn-t models surpassing high-performance hybrid models with customization capability,” arXiv preprint arXiv:2007.15188, 2020.
[22] V. Panayotov, G. Chen, D. Povey, and S. Khudanpur, “Lib-riSpeech: An ASR corpus based on public domain audio books,” in 2015 IEEE International Conference on Acoustics, Speech and Signal Processing (ICASSP), April 2015, pp. 5206-5210.
[23] E. A. Lehmann and A. M. Johansson, “Prediction of energy decay in room impulse responses simulated with an image-source model,” The Journal of the Acoustical Society of America, vol. 124, no. 1, pp. 269-277, 2008.
[24] F. Bahmaninezhad, J. Wu, R. Gu, S.-X. Zhang, Y. Xu, M. Yu, and D. Yu, “A comprehensive study of speech separation: Spectrogram vs waveform separation,” arXiv preprint arXiv:1905.07497, 2019.
[25] Y. Shi, Y. Wang, C. Wu, C.-F. Yeh, J. Chan, F. Zhang, D. Le, and M. Seltzer, “Emformer: Efficient memory transformer based acoustic model for low latency streaming speech recognition,” in ICASSP 2021-2021 IEEE International Conference on Acoustics, Speech and Signal Processing (ICASSP). IEEE, 2021, pp. 6783-6787.

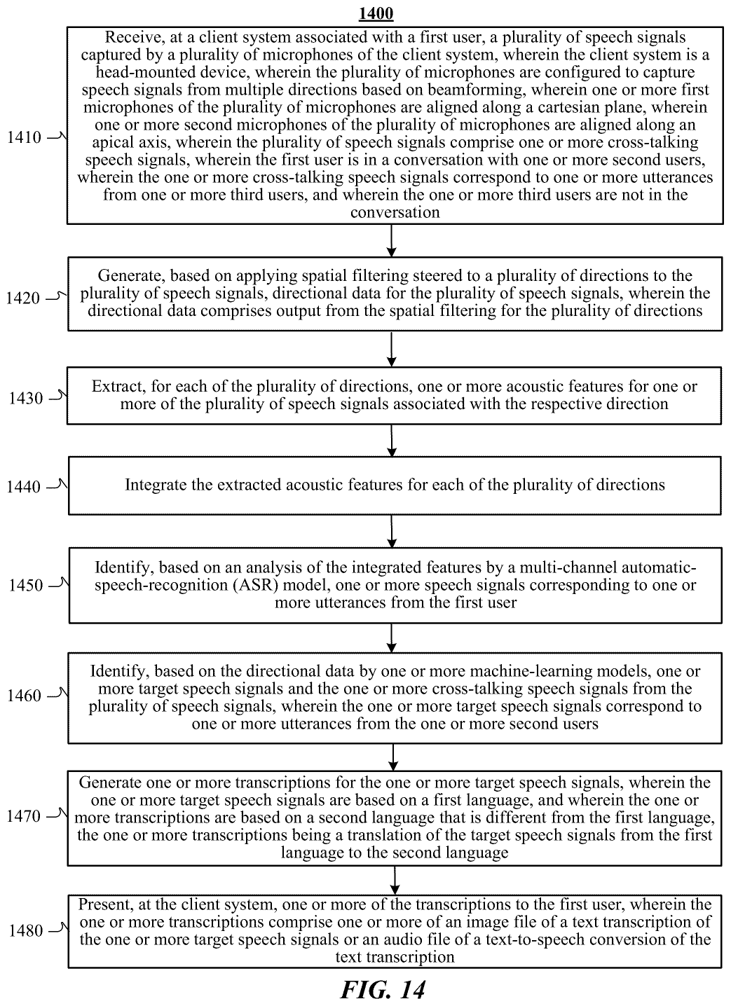

FIG. 14 illustrates an example method 1400 for suppressing crosstalk. The method may begin at step 1410, where one or more computing systems may receive, at a client system 130 associated with a first user, a plurality of speech signals captured by a plurality of microphones of the client system 130, wherein the client system 130 is a head-mounted device, wherein the plurality of microphones are configured to capture speech signals from multiple directions based on beamforming, wherein one or more first microphones of the plurality of microphones are aligned along a cartesian plane, wherein one or more second microphones of the plurality of microphones are aligned along an apical axis, wherein the plurality of speech signals comprise one or more cross-talking speech signals, wherein the first user is in a conversation with one or more second users, wherein the one or more cross-talking speech signals correspond to one or more utterances from one or more third users, and wherein the one or more third users are not in the conversation. At step 1420, the one or more computing systems may generate, based on applying spatial filtering steered to a plurality of directions to the plurality of speech signals, directional data for the plurality of speech signals, wherein the directional data comprises output from the spatial filtering for the plurality of directions. At step 1430, the one or more computing systems may extract, for each of the plurality of directions, one or more acoustic features for one or more of the plurality of speech signals associated with the respective direction. At step 1440, the one or more computing systems may integrate the extracted acoustic features for each of the plurality of directions. At step 1450, the one or more computing systems may identify, based on an analysis of the integrated features by a multi-channel automatic-speech-recognition (ASR) model, one or more speech signals corresponding to one or more utterances from the first user. At step 1460, the one or more computing systems may identify, based on the directional data by one or more machine-learning models, one or more target speech signals and the one or more cross-talking speech signals from the plurality of speech signals, wherein the one or more target speech signals correspond to one or more utterances from the one or more second users. At step 1470, the one or more computing systems may generate one or more transcriptions for the one or more target speech signals, wherein the one or more target speech signals are based on a first language, and wherein the one or more transcriptions are based on a second language that is different from the first language, the one or more transcriptions being a translation of the target speech signals from the first language to the second language. At step 1480, the one or more computing systems may present, at the client system, one or more of the transcriptions to the first user, wherein the one or more transcriptions comprise one or more of an image file of a text transcription of the one or more target speech signals or an audio file of a text-to-speech conversion of the text transcription. Particular embodiments may repeat one or more steps of the method of FIG. 14, where appropriate. Although this disclosure describes and illustrates particular steps of the method of FIG. 14 as occurring in a particular order, this disclosure contemplates any suitable steps of the method of FIG. 14 occurring in any suitable order. Moreover, although this disclosure describes and illustrates an example method for suppressing crosstalk including the particular steps of the method of FIG. 14, this disclosure contemplates any suitable method for suppressing crosstalk including any suitable steps, which may include all, some, or none of the steps of the method of FIG. 14, where appropriate. Furthermore, although this disclosure describes and illustrates particular components, devices, or systems carrying out particular steps of the method of FIG. 14, this disclosure contemplates any suitable combination of any suitable components, devices, or systems carrying out any suitable steps of the method of FIG. 14.

### Improving Data and Model Quality Through Label Error Detection and Overwrite

In particular embodiments, a computing system may improve the quality of data used in supervised training of machine-learning models using a label error detection and overwrite (LEDO) method. The LEDO method may be based on three main components: (1) a sentinel model that can detect label errors; (2) Monte Carlo dropout that can provide a distribution of model predictions; and (3) an uncertainty metric that can depict a model's confidence about its prediction. The LEDO method may automatically detect label errors that exist in the data. After the errors are detected, the LEDO method may apply two remedies. If the method is confident about an overwrite action, it may automatically overwrite the label. If overwrite is not possible, it may flag these potential errors to request additional annotation. In addition to label correction, LEDO framework can also be integrated with model training pipeline for machine-learning models to rely more on certain training samples than others. This process may expedite the model training with a feedback loop with LEDO and ensure models are trained on high quality labeled data. Although this disclosure describes particular label error detections in a particular manner, this disclosure contemplates any suitable label error detection in any suitable manner.

As a deep-learning model may require large amounts of data to train and may have the capacity to overfit to the errors existing in the data due to the “memorization effect”, the quality of the model may be highly dependent on the quality of the data. As an example and not by way of limitation, there may be challenges in data collection for opinion based question answering (e.g., “what is the best strawberry smoothie recipe?”). This may be because: 1) judgment of the relevance may be subjective and may have large variations due to the “opinion-based” nature; 2) annotation guidelines may be changing as our design and judging criteria are evolving; and 3) for dense passage retriever (DPR) (i.e., a state-of-the-art retrieval model used in open-domain question and answering systems) in particular, the traditional way of using BM25 and answer spans to mine hard negatives may no longer be used for the opinion-based system, since there is no unique, gold answer to the question.

In supervised models, label noise may refer to data examples where the target label was incorrectly assigned. Some examples of label noise are described as follows. In DPR, for a question “Anyone on here play the new avengers game?” a positive post may be “Anyone else besides me is playing the new game Rogue Company?” Note that the negative post is marked as positive. In machine reading comprehension (MRC), for a question “anybody have a copycat recipe of the schools tomato soup?” a post may be “Does anyone have a good homemade tomato soup recipe? My Mimi made the best tomato soup and I haven't had any since she passed several years ago.” A comment may be “Try Pinterest they have good recipes.” Note that bad answer is marked as good. In ranker model, for a question “anyone have a mini fridge they want to sell?” a post may be “Does anyone have a mini fridge or a small microwave they don't want or need? It's for my college dorm.” A comment may be “I think my friend is getting rid of a microwave.” The answer ranking score may be 5.

Label noise may be a prevalent problem for almost all the supervised machine learning models that require human annotated data. It may be well known that human annotated data may be expensive to obtain, and in many situations, high-quality annotated data may be even harder to collect due to the ambiguity of the annotation guidelines, the annotators not paying enough attention, or not having the skills to accomplish the annotation task (e.g., low-resource language annotation).

To improve the data quality, one may hire more “qualified” annotators, establish quality control criteria for accepting annotations, incrementally improve the annotation guidelines and train the annotators, impose conflict resolution, and repeat the process for multiple rounds. This may have a good chance of collecting better quality data. However, this process may be very expensive and may not be achieved quickly due to resource constraints.

To address the aforementioned issues, the embodiments disclosed herein developed the LEDO method that can automatically detect label noise with high precision, and whenever possible, overwrite the label to be the correct one.

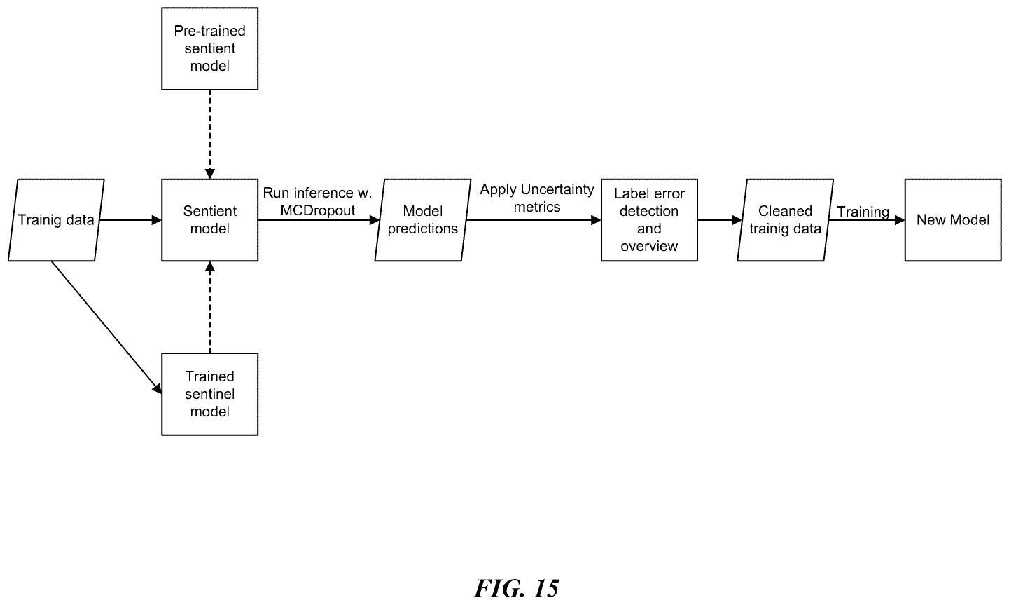

FIG. 15 illustrates an example framework for label error detection and overwrite. In particular embodiments, the LEDO method may be based on the following components. The method may be firstly based on a sentinel model. The sentinel model may be of the same architecture of the base model that one is trying to improve, or an external model that may make reasonable predictions on a similar task of the base model. The sentinel model may be a more powerful model that runs offline, and it may be not subject to constraints of runtime. To train the sentinel model, one may use cross-validation, where one trains sentinel model on only a portion of the data (e.g., half) so it doesn't get as influenced by errors in the data. Alternatively, one may use a pre-trained model that has been trained on a different dataset of larger size.

The LEDO method may be also based on Monte Carlo dropout. Monte Carlo dropout has been proven to be able to provide approximate Bayesian inference for deep-learning models that can describe uncertainty of existing models without sacrificing computation complexity or test accuracy. Monte Carlo dropout may be implemented conveniently by applying random masks on selected layers of given deep-learning models that have been already trained. Monte Carlo dropout may not only give us point predictions from existing models as normal inference does, but also depict how confident the subject model is about a given input through its distribution. This information was previously thrown away during inference time by conventional work, and may equip us with useful information about detecting and correcting label errors.

The LEDO method may be further based on uncertainty metrics. Having a distribution of model predictions may allow us to use metrics as mean, standard deviation, quantile, variation ratio, aleatoric uncertainty, etc. to infer uncertainty.

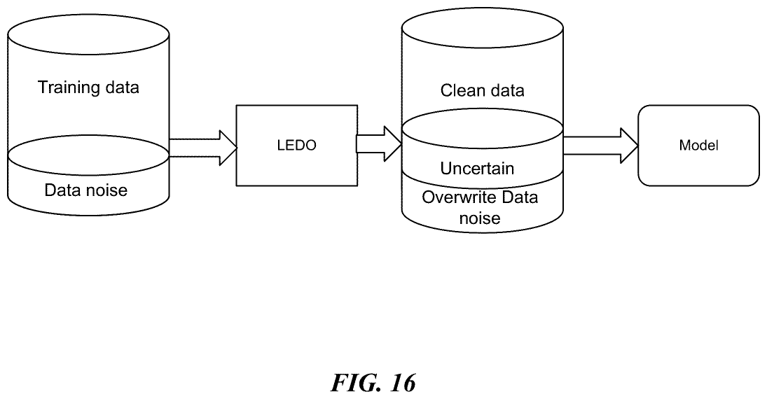

FIG. 16 illustrates another example flow diagram to achieve better data efficiency. The LEDO method may improve data quality without any additional annotation.

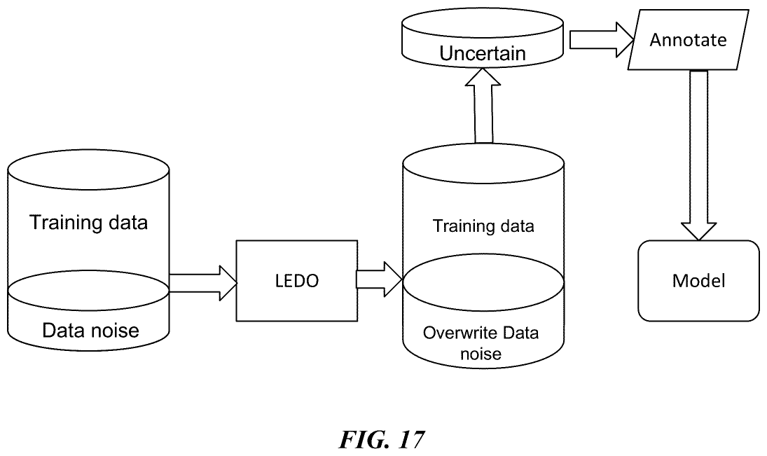

FIG. 17 illustrates another example flow diagram to achieve better data efficiency. The LEDO method may improve data quality with some additional annotation.

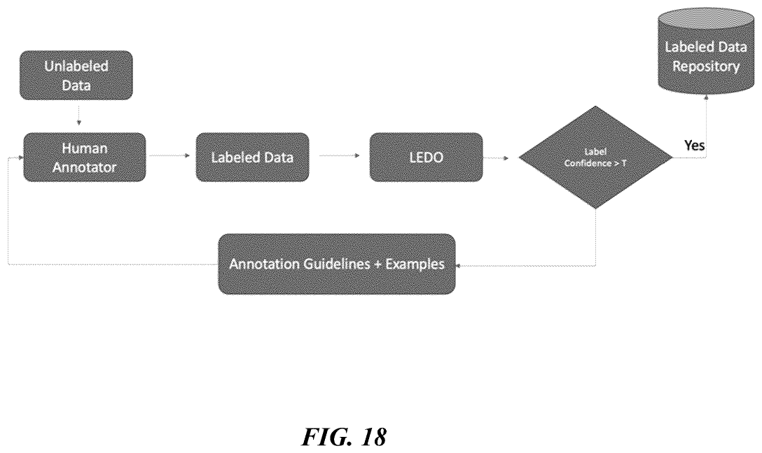

As an extension, LEDO may also help train the human annotators in real time and guide them in real time to eliminate label error due to annotators fatigue, human bias, judgmental etc. During data annotation process, LEDO verifies the label noise and upon detecting error in label, provide the annotation guidelines to the annotator and share examples of correct label hence educate the annotator in real time. FIG. 18 illustrates an example flow diagram for assisting human annotators.

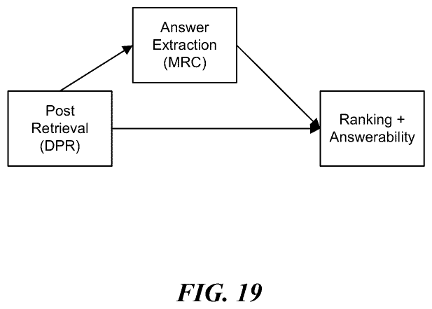

In particular embodiments, the LEDO method may be applied on question answering (QA). FIG. 19 illustrates an example QA system architecture. In particular embodiments, the LEDO method may be used in the MRC model. As an example and not by way of limitation, the sentinel model may be based on RoBERTa large MRC model created by cross validation. Monte Carlo dropout may be 10 and uncertainty metric may be mean and standard deviation.

Table 5 lists example data statistics of the LEDO method on QA MRC model. Table 6 lists evaluation results of the LEDO method on QA MRC model.

TABLE 5
Example data statistics

| Model | Training data size | Cleaning criteria | % data cleaned |
|---|---|---|---|
| MRC | 750k | Mean & std | 7% |

TABLE 6
Example evaluation results.

| Model | Experiment | F1 | PR AUC |
|---|---|---|---|
| MRC | Baseline | 78.6 | 76 |
| | New | 79.6 | 77.5 |

The embodiments disclosed herein performed experiments to validate the LEDO method. Some example label errors that are corrected by the LEDO method are as follows. One type is bad answers marked as good. For example, a question may be “search how to make the famous red ranch sauce” and a post may be “How do you guys make your copycat red ranch?” A comment may be “It's called red ranch.” Another type may be post not highly relevant to the question. For example, a question may be “does anyone have any fried rice egg roll recipe ideas?” and a post may be “Looking for simple recipe ideas. Craving something like smoked sausage and fried rice. Anyone have any similar recipes they'd be willing to share?” A comment may be “sausage and peppers over rice or noodles.” Another type may be good answers marked as bad. For example, a question may be “does anybody have any recipes for boneless pork loin in the crockpot?” and a post may be “I have a boneless pork loin that I'm going to put in the crockpot tomorrow . . . any suggestions?” A comment may be “Onion, bell peppers, sweet and sour sauce, cook low 6-8 hours, add can of pineapple chunks, slice and serve over rice potatoes or pasta.”

In particular embodiments, the LEDO method may be applied to the QA ranker. Answer ranker may sort the post-comment pairs according to their relevance, which may be important for good experience on smart assistants as users often do not explore past the top answer. The modeling may be based on features which include model outputs and metadata, model which may be a neural network, and loss which may be based on Lambda Rank. Table 7 lists some example features.

TABLE 7
Example features.

| Feature | Scaling |
|---|---|
| answer_extraction_score | |
| retrieval_score | min_max(740, 768) |
| post_likes | min_max(0, 10) |
| post_likes | min_max(0, 10) |
| comment_likes | min_max(0, 10) |
| comment_replies | min_max(0, 10) |
| comment_views | min_max(0, 100) |
| poster_likes_comment | |

As an example and not by way of limitation, when applied on QA ranking model, the sentinel model may be based on a RoBERTa large classifier with negative, neutral, positive targets, the Monte Carlo dropout may be 10, and the uncertainty metric may be 10% percentile confidence on positive <0.5, then error.

The embodiments disclosed herein validated the LEDO method on QA ranking model based on the following dataset. 1-5 ranks for posts and comments given a question. 10K questions and total of 100K post-comment pairs. 20% positive answers (ratings 4,5) and 80% incorrect answers (ratings 1,2,3).

Table 8 lists example evaluation results. Note that combined Average Precision (AP) indicates combined ranking and answerability average precision and the results on ranker are averaged over 5 runs.

TABLE 8
Example evaluation results.

| Model | Experiment | Combined AP |
|---|---|---|
| Ranker | Baseline | 77.9 |
| | New | 78.8 |

An example of label errors that are corrected by the LEDO method is as follows. A question may be “What's everyone's at home Chinese foods?” A post may be “What's your favorite home cooked meal?” A comment may be “Spaghetti with ground sausage and meatballs.” A rating may be original 4, corrected to 2.

In particular embodiments, the LEDO method may be applied to the DPR model. As an example and not by way of limitation, the sentinel model may be a MNLI model that generates Entailment, Contradiction and Neutral score, the Monte Carlo dropout may be 8 with 2 variations (Ques<sep>Passage and Passage<sep>Ques), and the uncertainty metric may be mean and standard deviation.

An example use case may be as follows. A user may ask “what is the best recipe for cooking salmon?” Annotators may need to review lots of answers and label/rank question/answer pairs to find the best answers. But the problem may be that this is a very subjective question. A dense passage retrieval (DPR) model may be used to retrieve answers. To improve the data quality, the computing system may feed the training data to the sentinel model, which may be set up to also be a DPR model, or a natural language inference model, or some other type of models. The output of the sentinel model may be processed by Monte Carlo dropout. The LEDO method may further apply uncertainty metrics on the output of Monte Carlo dropout to detect label errors of the training data and overwrite them. The improved training data may be then used to refine the DPR model for question and answering.

With LEDO, false positives were removed using contradiction scores and false negatives were removed using entailment scores, and other sentence similarity model scores.

Examples of label errors that are corrected by the LEDO method are as follows. One type of label error may be false positive. For example, a question may be “can someone recommend a fine dining place that is available?” A post may be “can someone recommend a good place for breakfast that had outside dining?” Another type may be false negative. For example, a question may be “is there a Vietnamese sub in the area?” A post may be “where can one find Vietnamese sandwiches here?”

Table 9 lists additional experimental results where the LEDO method is applied on the QA Answer Extraction (MRC) model, Answer Ranking model and DPR model.

TABLE 9
Example results on DPR models.

| Experiment | MRR | Avg Rank |
|---|---|---|
| Baseline | 84.06 | 4.43 |
| +LEDO | 85.13 | 3.38 |

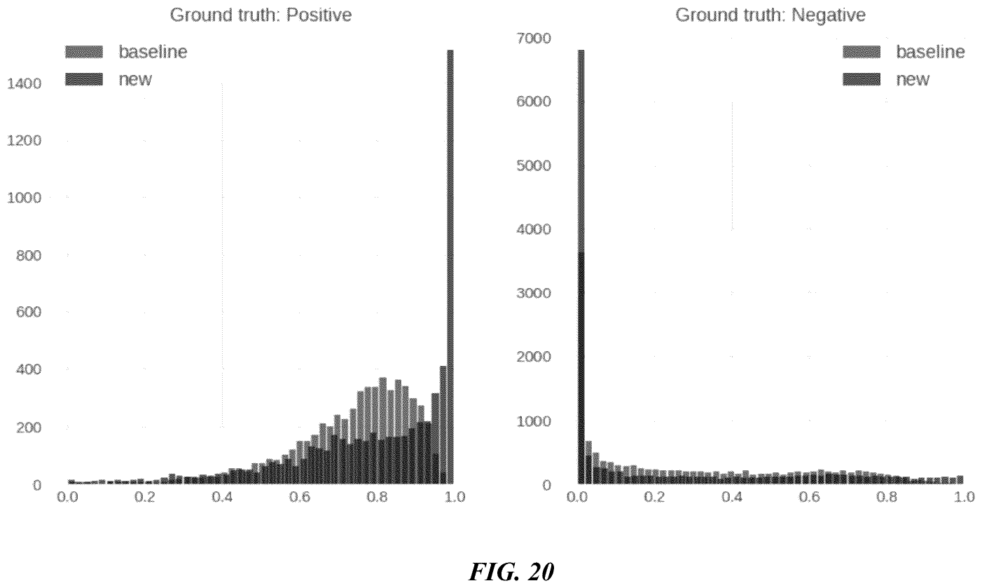

FIG. 20 illustrates example changes in the new MRC model. The following types of examples may be improved. One type may be bad answers marked as good. For example, a question may be “how do i make shrimp kabobs.” A post may be “how do i make shrimp kabobs.” A comment may be “a, b, c, d, e.” The model confidence of the baseline model may be 0.51 whereas that of the new model may be 0.04. Another type may be post not related to question. For example, a question may be “look up green bean casserole recipes.” A post may be “So the only recipe I've used French style green beans in is green bean casserole. What else do y'all do with them? I really like them and want to use them in more recipes. Bonus point if its dairy free or I if can use a dairy free sub!” A comment may be “Drain all the water off them, then lightly fry them and add cream cheese and butter, a couple gloves of garlic, salt n pepper to taste. Creamed green beans.” The model confidence of the baseline model may be 0.65 whereas that of the new model may be 0.36.

In particular embodiments, the LEDO method may be additionally applied to improve natural language understanding, natural language generation, and question and answering. More information on natural language understanding, natural language generation, and question and answering may be found in U.S. patent application Ser. No. 16/176,081, filed 31 Oct. 2018, U.S. patent application Ser. No. 16/176,312, filed 31 Oct. 2018, and U.S. patent application Ser. No. 17/351,501, filed 18 Jun. 2021, each of which is incorporated by reference.

### Automatic Microphone Switching

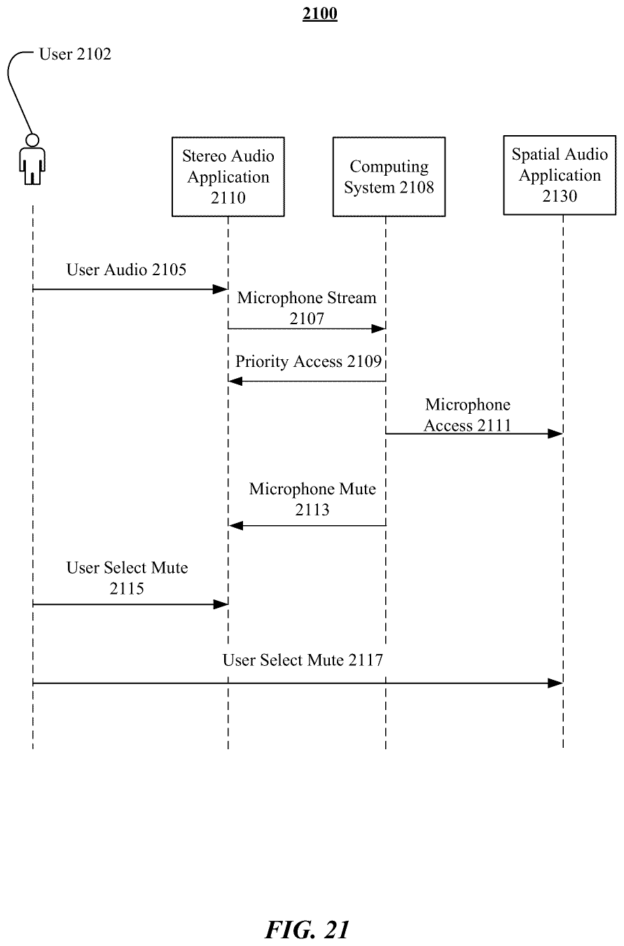

FIG. 21 illustrates an example sequence diagram of a process for automatically switching the audio communication for the user the first audio channel to a second audio channel when changing context in an XR environment. The user 2102 may be in a stereo audio application 2110 while in a spatial audio application 2130. The user 2102 may provide a user audio 2105. The default path routing the user audio 2105 may be set using stereo audio channel for the stereo audio application 2110, the stereo audio application 2110 may open a microphone stream 2107. The computing system may grant a priority access 2109 to the stereo audio application 2110, and may then grant microphone access 2111 to the spatial audio application 230. The computing system may determine to further mute microphone for the stereo audio application based on determining a context of the user 2102. Additionally or alternatively, the user 2102 may selectively choose to mute the user audio 2105 for the stereo audio application 2110 and/or the spatial audio application 2130.

In particular embodiments, the one or more computing system 2108 may implement automatic audio channel switching capabilities for an audio communication among multiple users when using multiple applications with different audio capabilities within an extended reality (XR) environment. For example, a user may be running an immersive application using spatial audio, and a two-dimensional application using stereo audio. The method includes updating the voice-over-Internet-Protocol (VoIP) session reporting application programming interface (API), where the API is used by the immersive application to update users as to which users are located nearby one another in the XR environment. The method further includes allowing the audio communication to switch audio channels in response to the updated user locations (e.g., if the user's avatars enter the same room in a VR environment while on an application that uses stereo audio together, the audio may switch from stereo to spatial responsive to their locations being proximate to each other).

In particular embodiments, a user may be in an immersive application that uses spatial audio while using a system 2D application that uses stereo audio to conduct a 2D call with other users. The system needs to decide where to route the first user's voice. Traditionally, the first user may be provided with a user interface with a manual switch (e.g., a toggle button) to switch audio communication between in-app (spatial) and in-call (stereo) audio while talking. The users may want this audio channel switching to happen automatically, allowing the user to talk intuitively without the first user manually selecting audio transmission paths when one or more users in the call change context with respect to the first user (e.g., switching applications or switch locations in the XR environment). Automatic audio channel switching may be enabled for a system 2D application and a system immersive application. The automatic audio channel switching capabilities are enabled based on build-time permissions. The build-time permission may be implemented such that the system 2D application still gain priority access over the microphone for all other immersive applications, including the system immersive application or other third-party immersive applications. Automatic audio channel switching may be enabled for third-party applications. However, the build-time permission structure for the microphone may be set by operating system or platform providers and may not be modified or overridden by third-party applications. Therefore, a run-time permission structure in a secure manner is desired for enabling automatic audio channel switching for third-party immersive applications. The method disclosed herein utilizes a privacy sensitive flag used by 2D applications on the microphone. The method further includes detecting a change of context of the user based on location information received by the VoIP session reporting APIs, and determining to automatically switch audio channel (e.g., from a stereo audio channel to a spatial audio channel) based on the detected change of context.

In particular embodiments, the one or more computing systems may ensure that unauthorized applications cannot steal the microphone by giving different permissions to the applications according to the categorizations of the applications. The applications may be divided into system applications and third-party applications. The system applications are preinstalled on the device and have system permissions. The third-party applications are installed by the users and lack system permissions. There are two types of applications for the two categories of applications. The two types of applications may include immersive applications that may take over the user's entire view and render the world around the user such as VR chat, and 2D applications that may be rendered in a window or run in the background. The immersive applications today may not run in the background. The categories and types of application may overlap. For example, the set of system permissions may comprise an ALWAYS_CAPTURE permission only used by system applications. This ALWAYS_CAPTURE permission enables system applications to record even when another application has the microphone. For example, system 3D applications may have the ALWAYS_CAPTURE permission to capture audio, even when a 2D call is active. However, third-party applications cannot have the ALWAYS_CAPTURE permission for security reasons.

In particular embodiments, the one or more computing systems may automatically switch audio channel when a user changes context in the XR environment. For example, a first user may change context by switching from a system 2D application to an immersive application with respect to a second user. The system may automatically route voice chat between the first user and the second user based on the context they are in without the users needing to select which application should have access to their microphone and in which ways (e.g., through which audio channel) their voices may be transmitted. For example, the first user and the second user may have an audio communication in 2D and may decide to switch to an immersive application to have their avatars meet virtually. The system may detect a change of application of the first user from 2D application to 3D application and the second user is also in the same virtual location (e.g., same virtual room) as the first user, the system may switch the audio communication between the first and second users from a stereo audio channel to a spatial audio channel.

In particular embodiments, the system immersive application may have ALWAYS_CAPTURE permission for capturing audio while a 2D call is active. The system immersive application may use a custom VoIP Session Reporting API tightly coupled with 2D to communicate which users are co-located with each other in the instance of an XR application. For example, the XR application may use the custom VoIP Session Reporting API to communicate that User A and User B in a 2D call are also located in the same the XR application instance. User A and B's audio may be muted on the 2D call and routed via spatial audio channels so that users A and B hear each other in the immersive application with spatialized audio. In another example, User A and User B are in a 2D call but not in the same the XR application instance. User A and B's audio may not be muted on the 2D call. The system 2D application (2D) may run in the background. In another example, if User A is located in the XR application while in a 2D call, User A may be provided with a custom UI in the Call Bar that only allows User A to mute User A's voice in 2D. In another example, if User A is not located in the XR application (e.g., User A is in a third-party immersive application) while in a 2D call, User A may be provided with a normal UI in the Call Bar that allows User A to manage the microphone manually between a third-party application and 2D.

In particular embodiments, the system 2D application may have a PRIORITY_CAPTURE_MIC_AUDIO_INPUT permission attached to its microphone stream. The system immersive application may have an ALWAYS_CAPTURE_MIC_AUDIO_INPUT permission. The priority capture permission gives the system 2D application exclusive access to the microphone except for applications with the always capture permission. When a user chooses to mute the microphone, both the system 2D application and the system immersive application still listen to the microphone but do not transmit the data to other users. The ALWAYS_CAPTURE_MIC_AUDIO_INPUT permission is system-level permission, so only system applications may have this permission. The system application with this permission may still record even when another application has the microphone. With the priority capture permission and always capture permission for the system 2D and immersive applications, the system 2D and immersive applications may run simultaneously. The system may be able to switch audio channels based on the context change related to the application change of one or more users in the audio communication.

In particular embodiments, the automatic audio channel switching abilities may be extended to third-party immersive applications. Immersive applications, including both system immersive applications and third-party immersive applications, may be able to listen to the microphone while 2D or any other 2D applications in the background are running. The immersive applications may access VoIP Session Reporting APIs to read which users are located in the same context in the XR environment. Microphone APIs may allow for run-time prioritization of the microphone. Specifically, 2D applications may use a microphone privacy sensitive flag that 2D applications may specify on their microphone streams when created. The privacy sensitive flag can be set explicitly or may be inferred based on stream types. When this flag is enabled, other applications may be unable to access the microphone. The immersive application may be prevented from actively using the privacy sensitive flag so that immersive applications may not steal the microphone under the manual audio channel switching mode. All 2D applications may be prevented from accessing the microphone while an active immersive application controls the microphone or system applications control the microphone. For example, if the user launches a Web Browser while in one of the immersive or system experiences, the Web Browser will not have the microphone. System applications may be allowed to access the microphone with the ALWAYS_CAPTURE_MIC_AUDIO_INPUT permission (e.g., permission to always have access to the microphone). For example, although the Web Browser is a system 2D application, and thus may still not have microphone access. Particular system applications like 2D may utilize the privacy sensitive flag under the manual audio channel switching to maintain priority microphone capture and open a microphone stream without the privacy sensitive flag under automatic audio channel switching mode to share the microphone with the active immersive application. Optionally, system immersive applications may no longer need the always capture permission.

In particular embodiments, the applications may be allowed to make audio channel switching decisions based on what contexts multiple users are in for a co-playing environment, where the contexts may use multi-channel audio (e.g., spatialized channel, stereo channel). Additionally, the audio channel switching decisions may be made further based on whether the user's avatars proximate to each other in the XR environment. For example, the system may detect some users' avatars have entered the same virtual room, and the system may have spatial audio on a first audio channel for these users while other users on a 2D may have stereo audio on a second audio channel.

### Systems and Methods

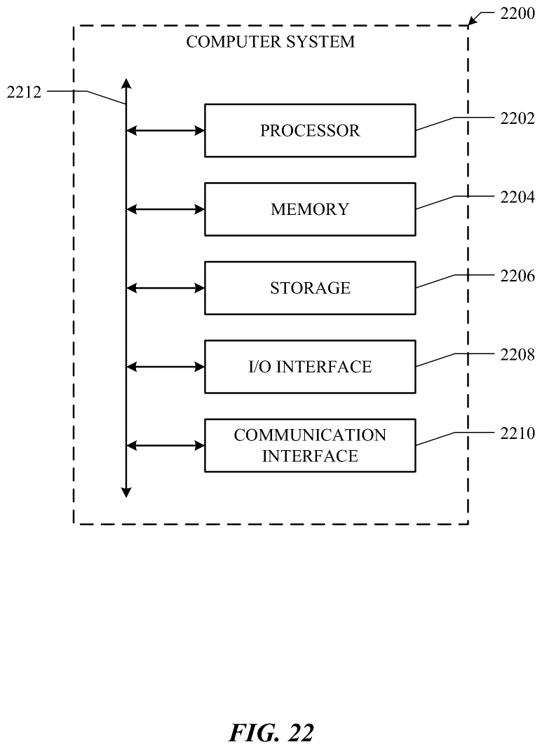

FIG. 22 illustrates an example computer system 2200. In particular embodiments, one or more computer systems 2200 perform one or more steps of one or more methods described or illustrated herein. In particular embodiments, one or more computer systems 2200 provide functionality described or illustrated herein. In particular embodiments, software running on one or more computer systems 2200 performs one or more steps of one or more methods described or illustrated herein or provides functionality described or illustrated herein. Particular embodiments include one or more portions of one or more computer systems 2200. Herein, reference to a computer system may encompass a computing device, and vice versa, where appropriate. Moreover, reference to a computer system may encompass one or more computer systems, where appropriate.

This disclosure contemplates any suitable number of computer systems 2200. This disclosure contemplates computer system 2200 taking any suitable physical form. As example and not by way of limitation, computer system 2200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2200 may include one or more computer systems 2200; be unitary or distributed; span multiple locations; span multiple machines; span multiple data centers; or reside in a cloud, which may include one or more cloud components in one or more networks. Where appropriate, one or more computer systems 2200 may perform without substantial spatial or temporal limitation one or more steps of one or more methods described or illustrated herein. As an example and not by way of limitation, one or more computer systems 2200 may perform in real time or in batch mode one or more steps of one or more methods described or illustrated herein. One or more computer systems 2200 may perform at different times or at different locations one or more steps of one or more methods described or illustrated herein, where appropriate.

In particular embodiments, computer system 2200 includes a processor 2202, memory 2204, storage 2206, an input/output (I/O) interface 2208, a communication interface 2210, and a bus 2212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2202 includes hardware for executing instructions, such as those making up a computer program. As an example and not by way of limitation, to execute instructions, processor 2202 may retrieve (or fetch) the instructions from an internal register, an internal cache, memory 2204, or storage 2206; decode and execute them; and then write one or more results to an internal register, an internal cache, memory 2204, or storage 2206. In particular embodiments, processor 2202 may include one or more internal caches for data, instructions, or addresses. This disclosure contemplates processor 2202 including any suitable number of any suitable internal caches, where appropriate. As an example and not by way of limitation, processor 2202 may include one or more instruction caches, one or more data caches, and one or more translation lookaside buffers (TLBs). Instructions in the instruction caches may be copies of instructions in memory 2204 or storage 2206, and the instruction caches may speed up retrieval of those instructions by processor 2202. Data in the data caches may be copies of data in memory 2204 or storage 2206 for instructions executing at processor 2202 to operate on; the results of previous instructions executed at processor 2202 for access by subsequent instructions executing at processor 2202 or for writing to memory 2204 or storage 2206; or other suitable data. The data caches may speed up read or write operations by processor 2202. The TLBs may speed up virtual-address translation for processor 2202. In particular embodiments, processor 2202 may include one or more internal registers for data, instructions, or addresses. This disclosure contemplates processor 2202 including any suitable number of any suitable internal registers, where appropriate. Where appropriate, processor 2202 may include one or more arithmetic logic units (ALUs); be a multi-core processor; or include one or more processors 2202. Although this disclosure describes and illustrates a particular processor, this disclosure contemplates any suitable processor.

In particular embodiments, memory 2204 includes main memory for storing instructions for processor 2202 to execute or data for processor 2202 to operate on. As an example and not by way of limitation, computer system 2200 may load instructions from storage 2206 or another source (such as, for example, another computer system 2200) to memory 2204. Processor 2202 may then load the instructions from memory 2204 to an internal register or internal cache. To execute the instructions, processor 2202 may retrieve the instructions from the internal register or internal cache and decode them. During or after execution of the instructions, processor 2202 may write one or more results (which may be intermediate or final results) to the internal register or internal cache. Processor 2202 may then write one or more of those results to memory 2204. In particular embodiments, processor 2202 executes only instructions in one or more internal registers or internal caches or in memory 2204 (as opposed to storage 2206 or elsewhere) and operates only on data in one or more internal registers or internal caches or in memory 2204 (as opposed to storage 2206 or elsewhere). One or more memory buses (which may each include an address bus and a data bus) may couple processor 2202 to memory 2204. Bus 2212 may include one or more memory buses, as described below. In particular embodiments, one or more memory management units (MMUs) reside between processor 2202 and memory 2204 and facilitate accesses to memory 2204 requested by processor 2202. In particular embodiments, memory 2204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2204 may include one or more memories 2204, where appropriate. Although this disclosure describes and illustrates particular memory, this disclosure contemplates any suitable memory.

In particular embodiments, storage 2206 includes mass storage for data or instructions. As an example and not by way of limitation, storage 2206 may include a hard disk drive (HDD), a floppy disk drive, flash memory, an optical disc, a magneto-optical disc, magnetic tape, or a Universal Serial Bus (USB) drive or a combination of two or more of these. Storage 2206 may include removable or non-removable (or fixed) media, where appropriate. Storage 2206 may be internal or external to computer system 2200, where appropriate. In particular embodiments, storage 2206 is non-volatile, solid-state memory. In particular embodiments, storage 2206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2206 taking any suitable physical form. Storage 2206 may include one or more storage control units facilitating communication between processor 2202 and storage 2206, where appropriate. Where appropriate, storage 2206 may include one or more storages 2206. Although this disclosure describes and illustrates particular storage, this disclosure contemplates any suitable storage.

In particular embodiments, I/O interface 2208 includes hardware, software, or both, providing one or more interfaces for communication between computer system 2200 and one or more I/O devices. Computer system 2200 may include one or more of these I/O devices, where appropriate. One or more of these I/O devices may enable communication between a person and computer system 2200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2208 for them. Where appropriate, I/O interface 2208 may include one or more device or software drivers enabling processor 2202 to drive one or more of these I/O devices. I/O interface 2208 may include one or more I/O interfaces 2208, where appropriate. Although this disclosure describes and illustrates a particular I/O interface, this disclosure contemplates any suitable I/O interface.

In particular embodiments, communication interface 2210 includes hardware, software, or both providing one or more interfaces for communication (such as, for example, packet-based communication) between computer system 2200 and one or more other computer systems 2200 or one or more networks. As an example and not by way of limitation, communication interface 2210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2210 for it. As an example and not by way of limitation, computer system 2200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2200 may include any suitable communication interface 2210 for any of these networks, where appropriate. Communication interface 2210 may include one or more communication interfaces 2210, where appropriate. Although this disclosure describes and illustrates a particular communication interface, this disclosure contemplates any suitable communication interface.

In particular embodiments, bus 2212 includes hardware, software, or both coupling components of computer system 2200 to each other. As an example and not by way of limitation, bus 2212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2212 may include one or more buses 2212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a VR system 130, a VR platform 140, a third-party system 170, a social-networking application 134, a VR application 136, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or VR platform 140 or shared with other systems (e.g., a third-party system 170). Although this disclosure describes using particular privacy settings in a particular manner, this disclosure contemplates using any suitable privacy settings in any suitable manner.

In particular embodiments, the social-networking system 160 or VR platform 140 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 or VR platform 140 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a VR system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or VR platform 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or VR platform 140 may access such information in order to provide a particular function or service to the first user, without the social-networking system 160 or VR platform 140 having access to that information for any other purposes. Before accessing, storing, or using such objects or information, the social-networking system 160 or VR platform 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or VR platform 140.

In particular embodiments, a user may specify whether particular types of objects or information associated with the first user may be accessed, stored, or used by the social-networking system 160 or VR platform 140. As an example and not by way of limitation, the first user may specify that images sent by the first user through the social-networking system 160 or VR platform 140 may not be stored by the social-networking system 160 or VR platform 140. As another example and not by way of limitation, a first user may specify that messages sent from the first user to a particular second user may not be stored by the social-networking system 160 or VR platform 140. As yet another example and not by way of limitation, a first user may specify that all objects sent via a particular application may be saved by the social-networking system 160 or VR platform 140.

In particular embodiments, privacy settings may allow a first user to specify whether particular objects or information associated with the first user may be accessed from particular VR systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or VR platform 140 may provide default privacy settings with respect to each device, system, or application, and/or the first user may be prompted to specify a particular privacy setting for each context. As an example and not by way of limitation, the first user may utilize a location-services feature of the social-networking system 160 or VR platform 140 to provide recommendations for restaurants or other places in proximity to the user. The first user's default privacy settings may specify that the social-networking system 160 or VR platform 140 may use location information provided from a VR system 130 of the first user to provide the location-based services, but that the social-networking system 160 or VR platform 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or VR platform 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or VR platform 140. The user's privacy settings may specify that such information may be used only for particular processes, such as authentication, and further specify that such information may not be shared with any third-party system 170 or used for other processes or applications associated with the social-networking system 160 or VR platform 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a client system associated with a first user:
receiving, at the client system, a plurality of speech signals captured by a plurality of microphones of the client system, wherein the plurality of speech signals comprise one or more cross-talking speech signals;
generating, based on applying spatial filtering steered to a plurality of directions to the plurality of speech signals, directional data for the plurality of speech signals, wherein the directional data comprises output from the spatial filtering for the plurality of directions;
identifying, based on the directional data by one or more machine-learning models, one or more target speech signals and the one or more cross-talking speech signals from the plurality of speech signals;
generating one or more transcriptions for the one or more target speech signals; and
presenting, at the client system, one or more of the transcriptions to the first user.

2. The method of claim 1, further comprising:
extracting, for each of the plurality of directions, one or more acoustic features for one or more of the plurality of speech signals associated with the respective direction; and
integrating the extracted acoustic features for each of the plurality of directions.

3. The method of claim 2, further comprising:
identifying, based on an analysis of the integrated features by a multi-channel automatic-speech-recognition (ASR) model, one or more speech signals corresponding to one or more utterances from the first user.

4. The method of claim 2, further comprising:
identifying, based on an analysis of the integrated features by a multi-channel automatic-speech-recognition (ASR) model, the one or more target speech signals from among the plurality of speech signals as corresponding to one or more utterances from one or more second users, wherein the one or more second users are in a conversation with the first user.

5. The method of claim 2, further comprising:
identifying, based on an analysis of the integrated features by a multi-channel automatic-speech-recognition (ASR) model, the one or more cross-talking speech signals from among the plurality of speech signals.

6. The method of claim 1, wherein generating the directional data is based on relative phase and intensity differences between the plurality of microphones.

7. The method of claim 1, wherein the one or more target speech signals are based on a first language, and wherein the one or more transcriptions are based on a second language that is different from the first language, the one or more transcriptions being a translation of the target speech signals from the first language to the second language.

8. The method of claim 1, wherein the one or more target speech signals correspond to one or more utterances from one or more second users in a conversation with the first user.

9. The method of claim 1, wherein the plurality of microphones are configured to capture speech signals from multiple directions based on beamforming.

10. The method of claim 1, wherein the first user is in a conversation with one or more second users, wherein the one or more cross-talking speech signals correspond to one or more utterances from one or more third users, and wherein the one or more third users are not in the conversation.

11. The method of claim 1, wherein generating the directional data is based on a beamforming signal processing algorithm.

12. The method of claim 11, wherein the one or more machine-learning models comprise a multi-channel automatic-speech-recognition (ASR) model, wherein generating the directional data based on the beamforming signal processing algorithm comprises:
mapping temporal differences associated with the plurality of speech signals to intensity differences; and
inputting the intensity differences to the multi-channel ASR model.

13. The method of claim 1, further comprising:
generating one or more translations for one or more speech signals corresponding to one or more utterances from the first user, wherein the presented one or more transcriptions are of the one or more translations.

14. The method of claim 1, wherein the client system is a head-mounted device.

15. The method of claim 1, wherein one or more first microphones of the plurality of microphones are aligned along a cartesian plane, and wherein one or more second microphones of the plurality of microphones are aligned along an apical axis.

16. The method of claim 1, wherein the first user is in a conversation with one or more second users, wherein the method further comprises:
detecting a change from the first user speaking to one of the one or more second users speaking; and
determining one or more second target speech signals of the target speech signals subsequent to the detected change correspond to one or more second utterances from the one of the second users;
wherein the one or more transcriptions comprise one or more second transcriptions for the one or more second target speech signals, and
wherein the one or more of the transcriptions presented to the first user comprise the one or more second transcriptions.

17. The method of claim 1, wherein the first user is in a conversation with one or more second users, wherein the plurality of speech signals comprise one or more first speech signals corresponding to one or more first utterances from the first user, wherein the plurality of speech signals comprise one or more second speech signals corresponding to one or more second utterances from one or more of the second users, wherein one or more of the first speech signals overlap with one or more of the second speech signals, and wherein the one or more target speech signals comprise the one or more of the second speech signals overlapping with the one or more of the first speech signals.

18. The method of claim 1, wherein the one or more transcriptions comprise one or more of:
an image file of a text transcription of the one or more target speech signals; or
an audio file of a text-to-speech conversion of the text transcription.

19. A method comprising, by one or more computing systems:
accessing a plurality of training data associated with a plurality of labels, respectively, wherein the plurality of training data was used to train a first machine-learning model configured to generate predictions for a first task;
generating, based on a second machine-learning model configured to generate reference predictions for the first task and a Monte Carlo dropout algorithm, one or more label errors associated with one or more of the labels associated with one or more of the training data and a distribution of the predicted label errors;
determining one or more confidence scores of the second machine-learning model with respect to the one or more label errors based on applying one or more uncertainty metrics to the distribution of the predicted label errors; and
applying, based on the confidence scores, one or more remedies to the one or more label errors, wherein the one or more remedies comprise one or more of overwrite the corresponding label error or flagging the corresponding label error.

20. A method comprising, by one or more computing systems:
maintaining a first audio communication between a first client system of a first user and a second client system of a second user, wherein the first audio communication is maintained on a first audio channel of a plurality of audio channels, wherein the first audio channel has a first set of audio capabilities;
detecting a context change of the first user with respect to the second user within an extended reality (XR) environment;
determining, based on the detected context change of the first user with respect to the second user, whether to switch audio channels of the first audio communication; and
automatically switching the first audio communication between the first client system and the second client system from the first audio channel to a second audio channel of the plurality of audio channels based on the determination, wherein the second audio channel has a second set of audio capabilities that are different from the first set of audio capabilities.

21. The method of claim 20, wherein detecting the context change comprising detecting a voice-over-Internet-Protocol (VoIP) session change via VoIP session reporting Application Programming Interfaces (APIs).

22. The method of claim 21, wherein the VoIP session reporting APIs allows applications to communicate which VoIP session the first user and the second user are located.

23. The method of claim 20, wherein the context change comprises an application change between a two-dimensional (2D) application and a three-dimensional (3D) application.

24. The method of claim 23, further comprising:
detecting the change of the context of the first user with respect to the second user comprises both the first user and the second user have switched from the 2D application to the 3D application;
muting the first audio communication between the first user and the second user via the first audio channel, wherein the first user's audio and the second user's audio are captured but not transmitted via the first audio channel, wherein the first audio channel is a stereo audio channel; and
routing the first audio communication between the first user and the second user via the second audio channel, wherein the second audio channel is a spatialized audio channel.

25. The method of claim 23, further comprising:
detecting the change of the context of the first user with respect to the second user comprises the first user has switched from the 2D application to the 3D application, and the second user remains in the 2D application;
continuing the first audio communication between the first and the second user via the first audio channel, wherein the first audio channel is a stereo audio channel.

26. The method of claim 25, further comprising:
detecting a third user is co-located with the first user in the 3D application;
establishing a second audio communication between the first user and the third user; and
routing the second audio communication via the second audio channel, wherein the second audio channel is a spatialized audio channel.

27. The method of claim 23, further comprising:
detecting the change of the context of the first user with respect to the second user comprises both the first user and the second user have switched from the 3D application to the 2D application;
unmuting the first audio communication via the first audio channel, wherein the first audio channel is a stereo audio channel; and
muting the first audio communication between the first user and the second user via the second audio channel, wherein the first user's audio and the second user's audio are captured but not transmitted via the second audio channel, wherein the second audio channel is a spatialized audio channel.

28. The method of claim 20, wherein the context change comprises a location change of a first avatar associated with the first user with respect to a second avatar associated with the second user within the XR environment.

29. The method of claim 28, further comprising:
detecting the change of the context of the first user with respect to the second user comprises the first avatar of the first user is proximate to the second avatar of the second user within a boundary of the XR environment; and
routing the first user's audio and the second user's audio via the second audio channel, wherein the second audio channel is a spatialized audio channel.

30. The method of claim 20, further comprising:
modifying a microphone access associated with the first audio communication via a microphone API in response to the switching the first audio communication automatically from the first audio channel to the second audio channel, wherein the microphone API is configured to allow a run-time prioritization of a microphone.

31. The method of claim 30, wherein the microphone API is further configured to enable a usage of a privacy sensitive flag for a particular context where the run-time prioritization over other contexts is required, wherein the privacy sensitive flag is associated with a microphone stream created under the particular context.

32. The method of claim 31, wherein the usage of the privacy sensitive flag is disabled when switching the first audio communication automatically from the first audio channel to the second audio channel, such that the first audio communication is shared with the detected context change of the first user with respect to the second user.
